(19) United States
(12) Patent Application Publication
(10) Pub. No.: US 2026/0133512 A1
(43) Pub. Date: May 14, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Yoichi KIGOSHI, Kanagawa (JP); Yuki OYAMADA, Kanagawa (JP); Kohei TAKAOKA, Kanagawa (JP); Fuyuki KANO, Kanagawa (JP); Keisuke KUSANO, Kanagawa (JP); Tomoya SASAKI, Kanagawa (JP); Ryosuke FUJII, Kanagawa (JP); Yuto OKAZAKI, Kanagawa (JP); Masahiro IWASAKI, Kanagawa (JP); Kenta IDE, Kanagawa (JP); Kosuke NARITA, Kanagawa (JP)

(73) Assignee: FUJIFILM Business Innovation Corp., Tokyo (JP)

(21) Appl. No.: 19/340,882

(22) Filed: Sep. 26, 2025

(30) Foreign Application Priority Data
Nov. 11, 2024 (JP) 2024-197014
Jul. 11, 2025 (JP) 2025-117606

(51) Int. Cl. G03G 5/07; G03G 21/18

(52) U.S. Cl. CPC G03G 5/071; G03G 21/1814

(57) ABSTRACT

An electrophotographic photoreceptor includes a conductive substrate, and a photosensitive layer disposed on the conductive substrate, in which an outermost surface layer contains a charge transport material, a polyarylate resin, and silicone oil, and a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

### CROSS-REFERENCE TO RELATED APPLICATIONS

This application is based on and claims priority under 35 USC 119 from Japanese Patent Application No. 2025-117606 filed Jul. 11, 2025 and Japanese Patent Application No. 2024-197014 filed Nov. 11, 2024.

### BACKGROUND

### (i) Technical Field

The present disclosure relates to an electrophotographic photoreceptor, a process cartridge, and an image forming apparatus.

### (ii) Related Art

JP1996-292584A (JP-H08-292584A) discloses a method for manufacturing an organic electrophotographic photoreceptor, in which in a method for manufacturing an organic electrophotographic photoreceptor where an organic electrophotographic photosensitive layer is formed on a conductive substrate by spray-coating, a coating solution for forming an organic electrophotographic photosensitive layer contains at least a binder resin and 0.002 parts by weight to 0.01 parts by weight of a silicone-based leveling agent with respect to 100 parts by weight of the binder resin.

JP1995-128879A (JP-H07-128879A) discloses an electrophotographic photoreceptor in which, in an electrophotographic photoreceptor where a charge generation layer and a charge transport layer are sequentially laminated on a conductive support, the charge transport layer contains ethoxy-modified silicone oil.

### SUMMARY

Aspects of non-limiting embodiments of the present disclosure relate to an electrophotographic photoreceptor that includes a conductive substrate, and a photosensitive layer disposed on the conductive substrate, in which in an electrophotographic photoreceptor where an outermost surface layer contains a charge transport material, a polyarylate resin, and silicone oil, as compared with a case where a content of the silicone oil in the outermost surface layer is less than 0.001 ppm or more than 15000.000 ppm, or a case where an amount of an aromatic carboxylic acid halide in the outermost surface layer is more than 15× 10-8 mol/g per unit mass of the outermost surface layer, a surface roughness due to coating film defects in the outermost surface layer is reduced.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects. Each formula is the same as the formula having the same number described later.

According to an aspect of the present disclosure, there is provided an electrophotographic photoreceptor including a conductive substrate, and a photosensitive layer disposed on the conductive substrate, in which an outermost surface layer contains a charge transport material, a polyarylate resin, and silicone oil, and a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to a first exemplary embodiment;

FIG. 2 is a partial cross-sectional view showing an example of a layer configuration of an electrophotographic photoreceptor according to a second exemplary embodiment;

FIG. 3 is a schematic configuration view showing an example of an image forming apparatus according to the present exemplary embodiment; and

FIG. 4 is a schematic configuration view showing a configuration of another example of the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, “A and/or B” is synonymous with “at least one of A or B”. That is, “A and/or B” means that A alone may be used, B alone may be used, or a combination of A and B may be used.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where a plurality of kinds of particles corresponding to each component are present in a composition, the particle diameter of each component indicates the value of a mixture of the plurality of kinds of particles present in the composition, unless otherwise specified.

In the present disclosure, an alkyl group and an alkylene group include all linear, branched, and cyclic shapes unless otherwise specified.

In the present disclosure, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “constitutional unit” of a copolymer or a resin is the same as a monomer unit.

### Electrophotographic Photoreceptor

An electrophotographic photoreceptor (hereinafter, also referred to as “photoreceptor”) according to the present exemplary embodiment includes a conductive substrate, and a photosensitive layer disposed on the conductive substrate.

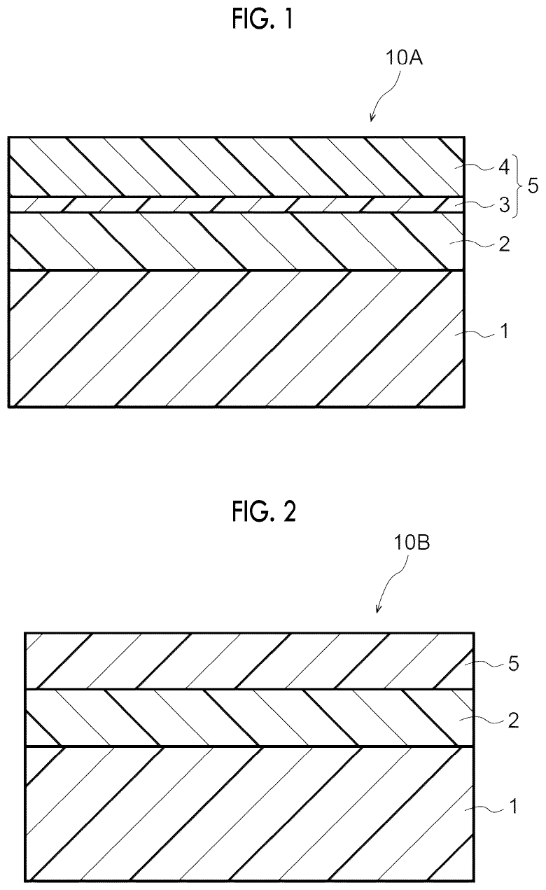

FIG. 1 is a partial cross-sectional view schematically showing an example of a layer configuration of the photoreceptor according to the present exemplary embodiment. A photoreceptor 10A shown in FIG. 1 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3. The undercoat layer 2 may or may not be provided.

FIG. 2 is a partial cross-sectional view schematically showing another example of the layer configuration of the photoreceptor according to the present exemplary embodiment. A photoreceptor 10B shown in FIG. 2 includes a single layer-type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5. The undercoat layer 2 may or may not be provided.

The electrophotographic photoreceptor according to the present exemplary embodiment has an outermost surface layer containing a charge transport material, a polyarylate resin, and silicone oil, in which a content of the silicone oil in the outermost surface layer is 0.001 ppm or more and 15000.000 ppm or less, and an amount of an aromatic carboxylic acid halide in the outermost surface layer is 15×10⁻⁸ mol/g or less per unit mass of the outermost surface layer.

According to an example of the exemplary embodiment, the photoreceptor includes a lamination-type photosensitive layer in which a charge generation layer and a charge transport layer are laminated, the charge transport layer is the outermost surface layer, and the charge transport layer constitutes an outer peripheral surface.

According to another example of the exemplary embodiment, the photoreceptor includes a single layer-type photosensitive layer, the single layer-type photosensitive layer is the outermost surface layer, and the single layer-type photosensitive layer constitutes an outer peripheral surface.

In the related art, the electrophotographic photoreceptor is manufactured by applying a coating solution for forming an outermost surface layer onto a photosensitive layer and drying the coating film in a step of manufacturing the outermost surface layer. In this case, in a case where a large amount of the aromatic carboxylic acid halide remains in the coating solution for forming an outermost surface layer (for example, more than 15×10⁻⁸ mol/g), local drying unevenness is likely to occur on the surface of the coating film. Due to this drying unevenness, a local thermal shrinkage difference occurs, and coating film defects such as repulsion and film thickness unevenness tend to occur. As a result, the surface of the outermost surface layer tends to be rough.

On the other hand, the electrophotographic photoreceptor according to the present exemplary embodiment has the above-described configuration, and thus the surface roughness due to the coating film defects of the outermost surface layer is reduced. The mechanism is not necessarily clear, but is presumed as follows.

In the electrophotographic photoreceptor according to the present exemplary embodiment, an amount of the aromatic carboxylic acid halide in the outermost surface layer is 15×10⁻⁸ mol/g or less per unit mass of the outermost surface layer. Therefore, even in a case of forming the outermost surface layer, the decrease in wettability due to the aromatic carboxylic acid halide in the coating film is suppressed, and thus local drying unevenness on the surface of the coating film is suppressed. As a result, the surface roughness due to coating film defects such as film thickness unevenness is reduced.

Furthermore, the electrophotographic photoreceptor according to the present exemplary embodiment contains a polyarylate resin and silicone oil in the outermost surface layer in addition to the charge transport material, and the content of the silicone oil in the outermost surface layer is 0.001 ppm or more. The polyarylate resin and the silicone oil are compatible with each other, and even in a case where the outermost surface layer is formed, components in the coating film are compatible with each other, and the local drying unevenness on the surface of the coating film is further suppressed. Therefore, the surface roughness due to the coating film defects such as the film thickness unevenness is reduced. In addition, since the content of the silicone oil in the outermost surface layer is 15000.000 ppm or less, even in a case of forming the outermost surface layer, the coating solution is suppressed from being repelled from the surface of the photosensitive layer due to excessive silicone oil. As a result, the surface roughness due to coating film defects such as coating film unevenness is further reduced.

### Outermost Surface Layer

The outermost surface layer contains a charge transport material, a polyarylate resin, and silicone oil, in which a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

Examples of the charge transport material include the same compound as the charge transport material contained in the charge transport layer described later. For example, the same applies to the preferred compound.

In the outermost surface layer, the residual amount of the aromatic carboxylic acid halide per unit mass of the outermost surface layer is 15×10⁻⁸ mol/g or less, and for example, preferably 12×10⁻⁸ mol/g or less and more preferably 10×10⁻⁸ mol/g or less. That is, the residual amount is, for example, preferably closer to 10×10⁻⁸ mol/g.

In a case where the amount of the aromatic carboxylic acid halide is equal to or smaller than the above-described range, even in a case of forming the outermost surface layer, the decrease in wettability due to the aromatic carboxylic acid halide in the coating film is suppressed, and thus local drying unevenness on the surface of the coating film is suppressed. As a result, the surface roughness due to coating film defects such as film thickness unevenness is reduced.

The residual amount of the aromatic carboxylic acid halide in the outermost surface layer per unit mass is quantified using high performance liquid chromatography (HPLC) by preparing a sample for measurement according to the following procedures (1) to (6).

(1) 2 g of diethylamine is dissolved in methylene chloride to prepare 100 g of a solution (1).

(2) The outermost surface layer is peeled off from the photoreceptor, and 1 g is accurately weighed.

(3) 1 g of the sample of the outermost surface layer is dissolved in the solution (1), and the solution is stirred overnight to react the aromatic carboxylic acid halide with diethylamine.

(4) Methylene chloride is distilled off under reduced pressure from the solution after the reaction.

(5) The residues are dissolved in 1 ml of N-methyl-2-pyrrolidone (good solvent for the polyester resin), and 9 ml of methanol (poor solvent for the polyester resin) is further added thereto to precipitate the polyester resin.

(6) The supernatant is filtered through a PTFE filter, and the filtrate is used as a measurement sample for HPLC.

HPLC is performed by using an ODS column as a separation column for HPLC, water containing phosphoric acid and acetonitrile as an eluent, and a photodiode array detector (example of the detection wavelength: 254 nm) as a detection device. The calibration curve for quantification is created by standard samples obtained by using 4,4′-biphenyldicarbonyl chloride and 4-(4-phenylcarbonyl chloride)benzoic acid as standard substances and dissolving each of the compounds in the solution (1) (preparing six samples with a concentration range of 1 ppm to 100 ppm). It is assumed that all carbonyl chloride terminals react with diethylamine to form a diamide compound (molecular weight of 352.5) or a monoamide compound (molecular weight of 260.7) in the standard sample.

The diamide compound and the monoamide compound formed by the reaction of the aromatic carboxylic acid halide with the diethylamine are respectively quantified by the above-described measuring method. The amounts (mol) of the substances are respectively calculated by dividing the mass of the quantified diamide compound by 352.5 and dividing the mass of the quantified monoamide compound by 260.7, and the calculated values are added up.

Specific methods for setting the residual amount of the aromatic carboxylic acid halide in the outermost surface layer per unit mass to be in the above-described range are not particularly limited, and examples thereof include a method for purifying the polyarylate resin in the coating solution for forming an outermost surface layer to remove the aromatic carboxylic acid halide. In a case of polymerization of the polyarylate resin, specific examples thereof include a method of increasing the purity of the monomer serving as a raw material; a method for sufficiently dissolving the monomer and initiating the polymerization reaction; and a method of setting the concentration of the dicarboxylic acid (specifically, a dicarboxylic acid chloride) in the polymerization reaction system to be low.

After the polymerization of the polyarylate resin, examples thereof include methods for reprecipitating and purifying the polyarylate resin in a solvent (for example, alcohol) which is a poor solvent for the polyarylate resin and a good solvent for the aromatic carboxylic acid halide and methods for performing an amine treatment on the polyarylate resin and decomposing the aromatic carboxylic acid halide.

### Polyarylate Resin

In the polyarylate resin, resin molecules are bonded to each other by an intermolecular force due to stacking of aromatic rings, and thus the abrasion resistance of the outermost surface layer is improved. As the polyarylate resin, for example, a polycondensate of bisphenols and an aromatic divalent carboxylic acid is preferable. Examples of the form of the polyarylate resin include a polyarylate resin (PA) described below. The polyarylate resin may be used alone or in combination of two or more kinds thereof.

The polyarylate resin preferably has, for example, a dicarboxylic acid unit represented by Formula (A) and a diol unit represented by Formula (B). In the present disclosure, the polyarylate resin is referred to as a polyarylate resin (PA).

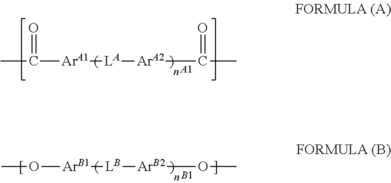

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2.

Where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The dicarboxylic acid unit (A) is a constitutional unit represented by Formula (A).

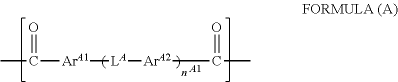

In Formula (A), Ar^{A1} and Ar^{A2} are each independently an aromatic ring which may have a substituent, L^{A} is a single bond or a divalent linking group, and n^{A1} is 0, 1, or 2.

The aromatic ring as Ar^{A1} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{A1} may be substituted with an alkyl group, an aryl group, an aralkyl group, an alkoxy group, an aryloxy group, a halogen atom, or the like. As the substituent in a case where the aromatic ring as Ar^{A1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{A2} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{A2} may be substituted with an alkyl group, an aryl group, an aralkyl group, an alkoxy group, an aryloxy group, a halogen atom, or the like. As the substituent in a case where the aromatic ring as Ar^{A2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

In a case where L^{A} is a divalent linking group, examples of the divalent linking group include an oxygen atom, a sulfur atom, and —C(Ra¹)(Ra²)—. Here, Ra¹ and Ra² are each independently a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded to each other to form a cyclic alkyl group.

The alkyl group having 1 or more and 10 or less carbon atoms, as Ra¹ and Ra², may be linear, branched, or cyclic. The number of carbon atoms of the alkyl group is, for example, preferably 1 or more and 6 or less, more preferably 1 or more and 4 or less, and still more preferably 1 or 2.

The aryl group having 6 or more and 12 or less carbon atoms, as Ra¹ and Ra², may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Ra¹ and Ra², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Ra¹ and Ra², may be a monocycle or a polycycle. The number of carbon atoms of the aryl group is, for example, preferably 6 or more and 10 or less and more preferably 6.

The dicarboxylic acid unit (A) preferably includes, for example, at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented by Formula (A4), and a dicarboxylic acid unit (A5) represented by Formula (A5). The dicarboxylic acid unit (A) includes, for example, more preferably at least one selected from the group consisting of a dicarboxylic acid unit (A2), a dicarboxylic acid unit (A3), and a dicarboxylic acid unit (A4) and still more preferably a dicarboxylic acid unit (A2).

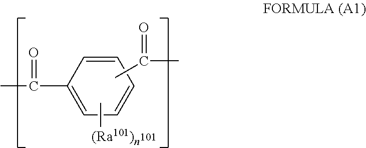

In Formula (A1), n¹⁰¹ is an integer of 0 or greater and 4 or less, and n101 pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms.

n¹⁰¹ is, for example, preferably 0, 1, or 2, more preferably 0 or 1, and still more preferably 0.

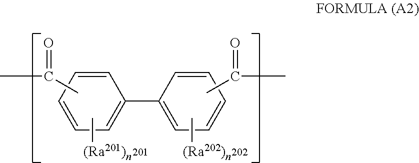

In Formula (A2), n²⁰¹ and n²⁰² are each independently an integer of 0 or greater and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms.

n²⁰¹ represents, for example, preferably 0, 1, or 2, more preferably 0 or 1, and still more preferably 0.

n²⁰² represents, for example, preferably 0, 1, or 2, more preferably 0 or 1, and still more preferably 0.

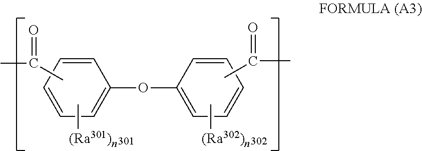

In Formula (A3), n³⁰¹ and n³⁰² are each independently an integer of 0 or greater and 4 or less, and n³⁰¹ pieces of Ra³⁰¹'s and n³⁰² pieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms.

n³⁰¹ is, for example, preferably 0, 1, or 2, more preferably 0 or 1, and still more preferably 0.

n³⁰² is, for example, preferably 0, 1, or 2, more preferably 0 or 1, and still more preferably 0.

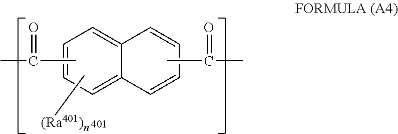

In Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms.

n⁴⁰¹ represents, for example, preferably an integer of 0 or greater and 4 or less, more preferably 0, 1, or 2, and still more preferably 0.

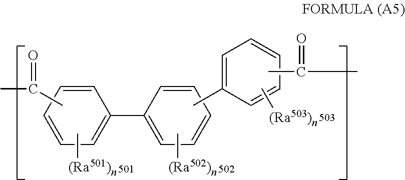

In Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

n⁵⁰¹ represents, for example, preferably 0, 1, or 2, more preferably 0 or 1, and still more preferably 0.

n⁵⁰² represents, for example, preferably 0, 1, or 2, more preferably 0 or 1, and still more preferably 0.

n⁵⁰³ represents, for example, preferably 0, 1, or 2, more preferably 0 or 1, and still more preferably 0.

The specific aspects and the preferred aspects of Ra¹⁰¹ in Formula (A1), Ra²⁰¹ and Ra²⁰² in Formula (A2), Ra³⁰¹ and Ra³⁰² in Formula (A3), Ra⁴⁰¹ in Formula (A4), and Ra⁵⁰¹, Ra⁵⁰², and Ra⁵⁰³ in Formula (A5) are the same as each other, and hereinafter, Ra¹⁰¹, Ra²⁰¹, Ra²⁰², Ra³⁰¹, Ra³⁰², Ra⁴⁰¹, Ra⁵⁰¹, Ra⁵⁰², and Ra⁵⁰³ will be collectively referred to as “Ra”.

The alkyl group having 1 or more and 10 or less carbon atoms as Ra may be linear, branched, or cyclic. The number of carbon atoms of the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, a n-propyl group, a n-butyl group, a n-pentyl group, a n-hexyl group, a n-heptyl group, a n-octyl group, a n-nonyl group, and a n-decyl group.

Examples of the branched alkyl group having 3 or more and 10 or less carbon atoms include an isopropyl group, an isobutyl group, an sec-butyl group, a tert-butyl group, an isopentyl group, a neopentyl group, a tert-pentyl group, an isohexyl group, an sec-hexyl group, a tert-hexyl group, an isoheptyl group, an sec-heptyl group, a tert-heptyl group, an isooctyl group, an sec-octyl group, a tert-octyl group, an isononyl group, an sec-nonyl group, a tert-nonyl group, an isodecyl group, an sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

The aryl group having 6 or more and 12 or less carbon atoms as Ra may be a monocycle or a polycycle. The number of carbon atoms of the aryl group is, for example, preferably 6 or more and 10 or less and more preferably 6.

Examples of the aryl group having 6 or more and 12 or less carbon atoms include a phenyl group, a biphenyl group, a 1-naphthyl group, and a 2-naphthyl group.

The alkyl group in the alkoxy group having 1 or more and 6 or less carbon atoms as Ra may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Hereinafter, dicarboxylic acid units (A1-1) to (A1-9) are shown as specific examples of the dicarboxylic acid unit (A1). The dicarboxylic acid unit (A1) is not limited thereto.

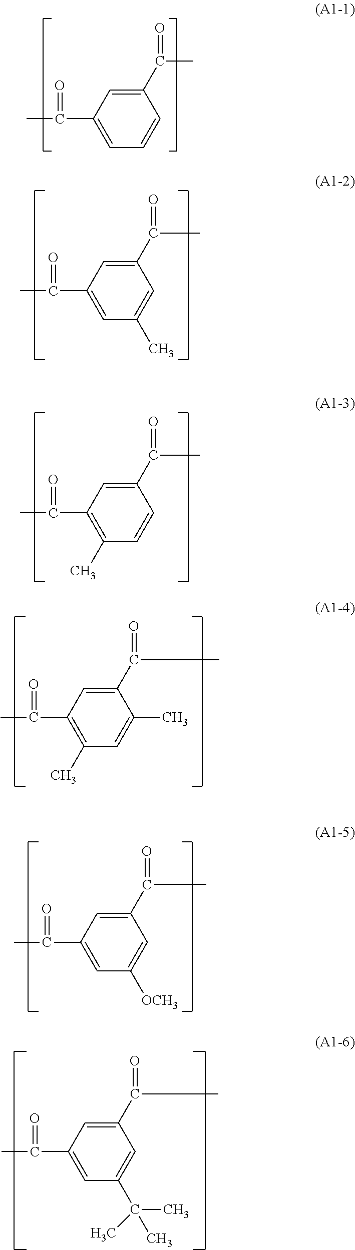

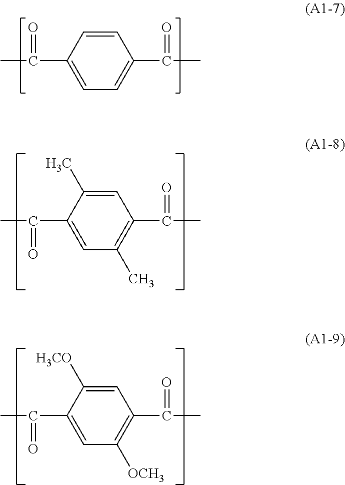

Hereinafter, dicarboxylic acid units (A2-1) to (A2-3) are shown as specific examples of the dicarboxylic acid unit (A2). The dicarboxylic acid unit (A2) is not limited thereto.

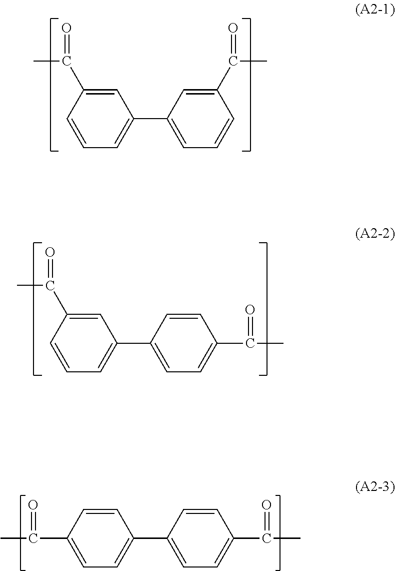

Hereinafter, dicarboxylic acid units (A3-1) and (A3-2) are shown as specific examples of the dicarboxylic acid unit (A3). The dicarboxylic acid unit (A3) is not limited thereto.

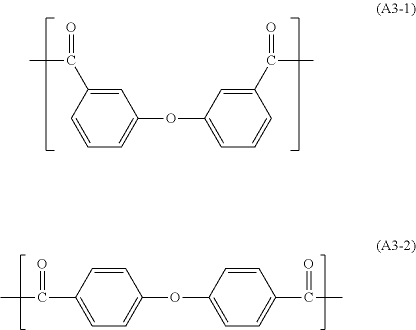

Hereinafter, dicarboxylic acid units (A4-1) to (A4-3) are shown as specific examples of the dicarboxylic acid unit (A4). The dicarboxylic acid unit (A4) is not limited thereto.

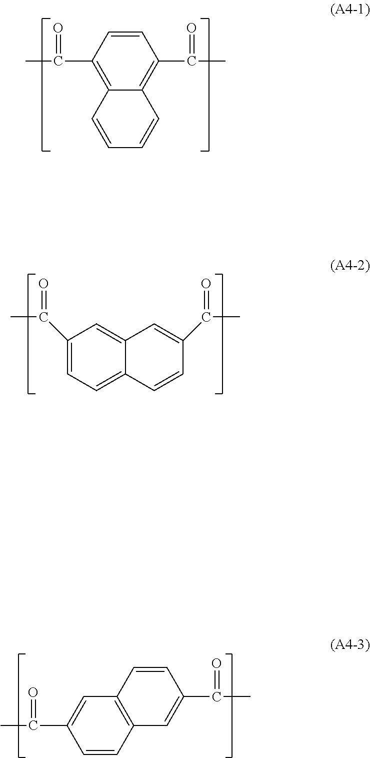

Hereinafter, dicarboxylic acid units (A5-1) to (A5-4) are shown as specific examples of the dicarboxylic acid unit (A5). The dicarboxylic acid unit (A5) is not limited thereto.

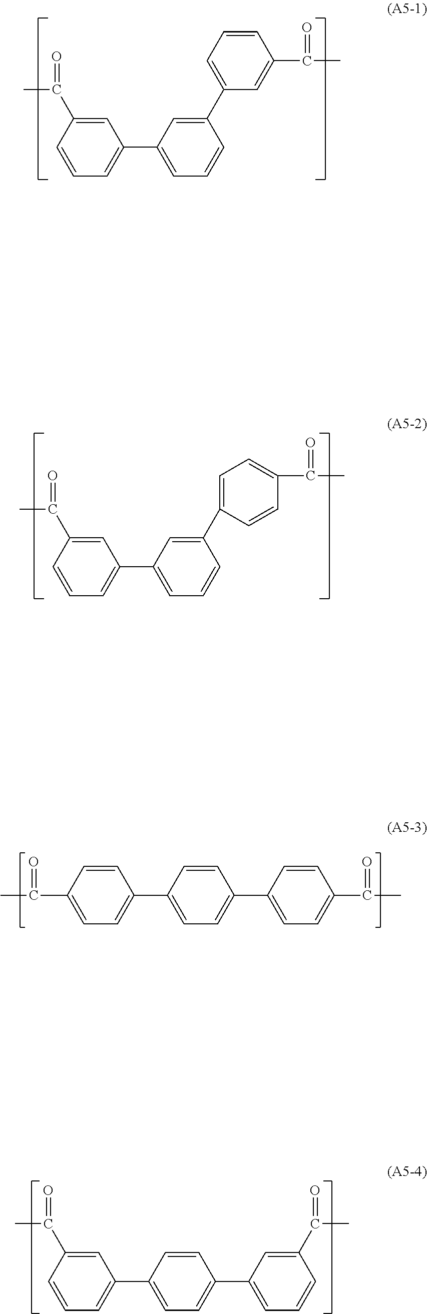

In the above-described specific examples, for example, at least one selected from the group consisting of (A1-1), (A1-7), (A2-3), (A3-2), and (A4-3) is preferably included, at least one selected from the group consisting of (A2-3), (A3-2), and (A4-3) is more preferably included, and at least (A2-3) is still more preferably included as the dicarboxylic acid unit (A).

The dicarboxylic acid unit (A) included in the polyarylate resin (PA) may be used alone or in combination of two or more kinds thereof.

A mass proportion of the dicarboxylic acid unit (A) in the polyarylate resin (PA) is, for example, preferably 15% by mass or more and 60% by mass or less.

In a case where the mass proportion of the dicarboxylic acid unit (A) is 15% by mass or more, the abrasion resistance of the outermost surface layer is enhanced. From the viewpoint, the mass proportion of the dicarboxylic acid unit (A) is, for example, more preferably 20% by mass or more, and still more preferably 25% by mass or more.

In a case where the mass proportion of the dicarboxylic acid unit (A) is 60% by mass or less, peeling of the outermost surface layer can be suppressed. From the viewpoint, the mass proportion of the dicarboxylic acid unit (A) is, for example, more preferably 55% by mass or less, and still more preferably 50% by mass or less.

The polyarylate resin (PA) may have other dicarboxylic acid units in addition to the dicarboxylic acid unit (A). Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower alkyl ester units (for example, having 1 or more and 5 or less carbon atoms) thereof. The dicarboxylic acid units included in the polyarylate resin (PA) may be used alone or in combination of two or more kinds thereof.

The diol unit (B) is a constitutional unit represented by Formula (B).

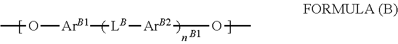

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2.

Where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{B2} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{B2} may be substituted with an alkyl group, an aryl group, an aralkyl group, an alkoxy group, an aryloxy group, a halogen atom, or the like. As the substituent in a case where the aromatic ring as Ar^{B2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The alkyl group having 1 or more and 20 or less carbon atoms, as Rb¹ and Rb², may be linear, branched, or cyclic. The number of carbon atoms of the alkyl group is, for example, preferably 1 or more and 18 or less, more preferably 1 or more and 14 or less, and still more preferably 1 or more and 10 or less.

The aryl group having 6 or more and 12 or less carbon atoms, as Rb¹ and Rb², may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Rb¹ and Rb², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Rb¹ and Rb², may be a monocycle or a polycycle. The number of carbon atoms of the aryl group is, for example, preferably 6 or more and 10 or less and more preferably 6.

It is preferable that the diol unit (B) includes, for example, at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

For example, the diol unit (B) more preferably includes at least one selected from the group consisting of the diol unit (B1) represented by Formula (B1), the diol unit (B2) represented by Formula (B2), the diol unit (B4) represented by Formula (B4), the diol unit (B5) represented by Formula (B5), and the diol unit (B6) represented by Formula (B6);
still more preferably includes at least one selected from the group consisting of the diol unit (B1) represented by Formula (B1), the diol unit (B2) represented by Formula (B2), the diol unit (B5) represented by Formula (B5), and the diol unit (B6) represented by Formula (B6);
even more preferably at least one selected from the group consisting of the diol unit (B1) represented by Formula (B1), the diol unit (B2) represented by Formula (B2), and the diol unit (B6) represented by Formula (B6); and
most preferably at least one selected from the group consisting of the diol unit (B1) represented by Formula (B1) and the diol unit (B2) represented by Formula (B2).

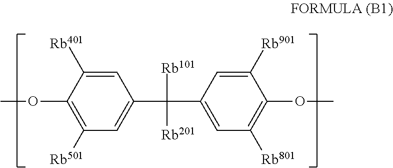

In Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

The number of carbon atoms in the branched alkyl group having 4 or more and 20 or less carbon atoms, as Rb¹⁰¹, is, for example, preferably 4 or more and 16 or less, more preferably 4 or more and 12 or less, and still more preferably 4 or more and 8 or less. Specific examples of Rb¹⁰¹ include an isobutyl group, an sec-butyl group, a tert-butyl group, an isopentyl group, a neopentyl group, a tert-pentyl group, an isohexyl group, an sec-hexyl group, a tert-hexyl group, an isoheptyl group, an sec-heptyl group, a tert-heptyl group, an isooctyl group, an sec-octyl group, a tert-octyl group, an isononyl group, an sec-nonyl group, a tert-nonyl group, an isodecyl group, an sec-decyl group, a tert-decyl group, an isododecyl group, an sec-dodecyl group, a tert-dodecyl group, a tert-tetradecyl group, and a tert-pentadecyl group.

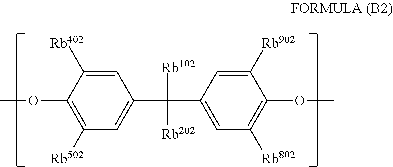

In Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 4 or more and 20 or less carbon atoms, as Rb¹⁰², is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

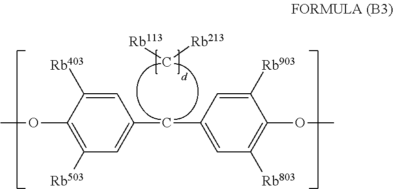

In Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹³ and Rb²¹³, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹³ and Rb²¹³, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, an sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

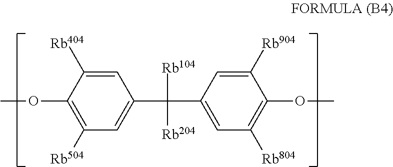

In Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms, as Rb¹⁰⁴, may be linear, branched, or cyclic. The number of carbon atoms in the alkyl group is, for example, preferably 1 or 2 and more preferably 1. Specific examples of Rb¹⁰⁴ include a methyl group, an ethyl group, an n-propyl group, an isopropyl group, and a cyclopropyl group.

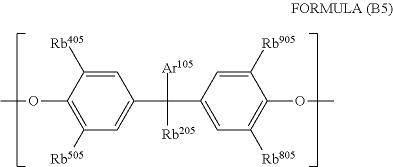

In Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms, as Ar¹⁰⁵, may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Ar¹⁰⁵, may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2. An aryl group of the aralkyl group having 7 or more and 20 or less carbon atoms, as Ar¹⁰⁵, may be a monocycle or a polycycle. The number of carbon atoms of the aryl group is, for example, preferably 6 or more and 10 or less and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

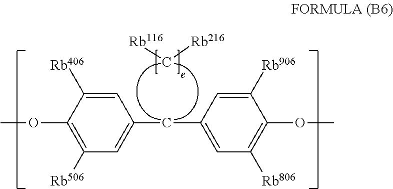

In Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹⁶ and Rb²¹⁶, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹⁶ and Rb²¹⁶, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, an sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

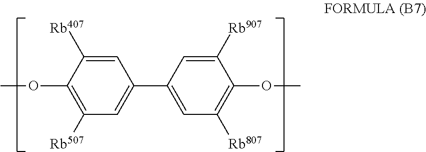

In Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

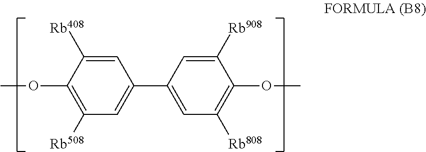

In Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

Specific forms and preferred forms of Rb²⁰¹ in Formula (B1), Rb²⁰² in Formula (B2), Rb²⁰⁴ in Formula (B4), and Rb²⁰⁵ in Formula (B5) are the same as each other, so that Rb²⁰¹, Rb²⁰², Rb²⁰⁴, and Rb²⁰⁵ will be collectively referred to as “Rb²⁰⁰”.

The alkyl group having 1 or more and 3 or less carbon atoms, as Rb²⁰⁰, may be linear, branched, or cyclic. The number of carbon atoms in the alkyl group is, for example, preferably 1 or 2 and more preferably 1.

Examples of the alkyl group having 1 or more and 3 or less carbon atoms include a methyl group, an ethyl group, an n-propyl group, an isopropyl group, and a cyclopropyl group.

Specific forms and preferred forms of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, so that Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms, as Rb⁴⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁴⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

Specific forms and preferred forms of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, so that Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms, as Rb⁵⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁵⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

Specific forms and preferred forms of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, so that Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms, as Rb⁸⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁸⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

Specific forms and preferred forms of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, so that Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰”.

The alkyl group having 1 or more and 4 or less carbon atoms, as Rb⁹⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁹⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Hereinafter, diol units (B1-1) to (B1-6) are shown as specific examples of the diol unit (B1). The diol unit (B1) is not limited thereto.

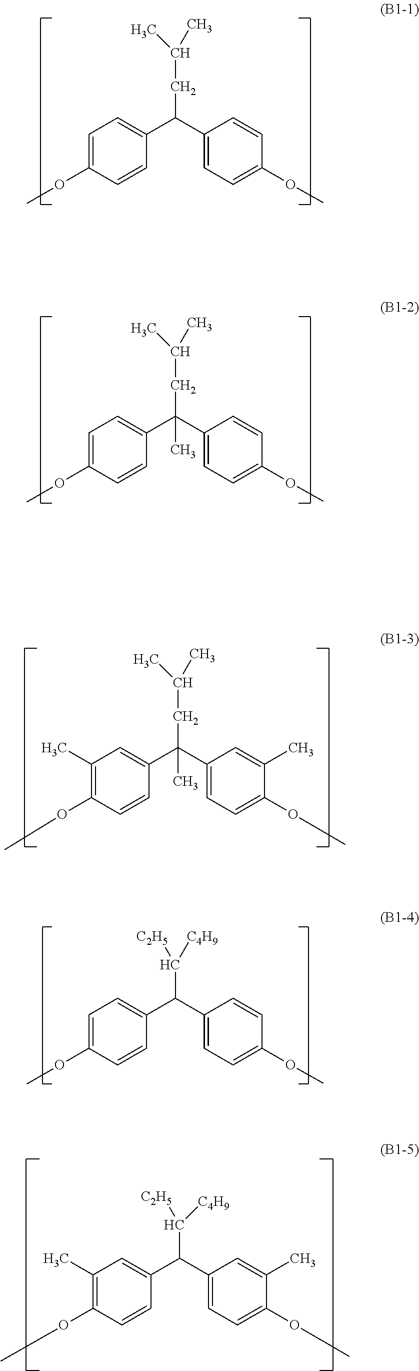

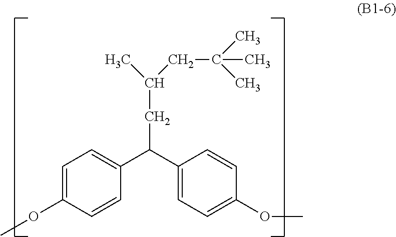

Hereinafter, diol units (B2-1) to (B2-11) are shown as specific examples of the diol unit (B2). The diol unit (B2) is not limited thereto.

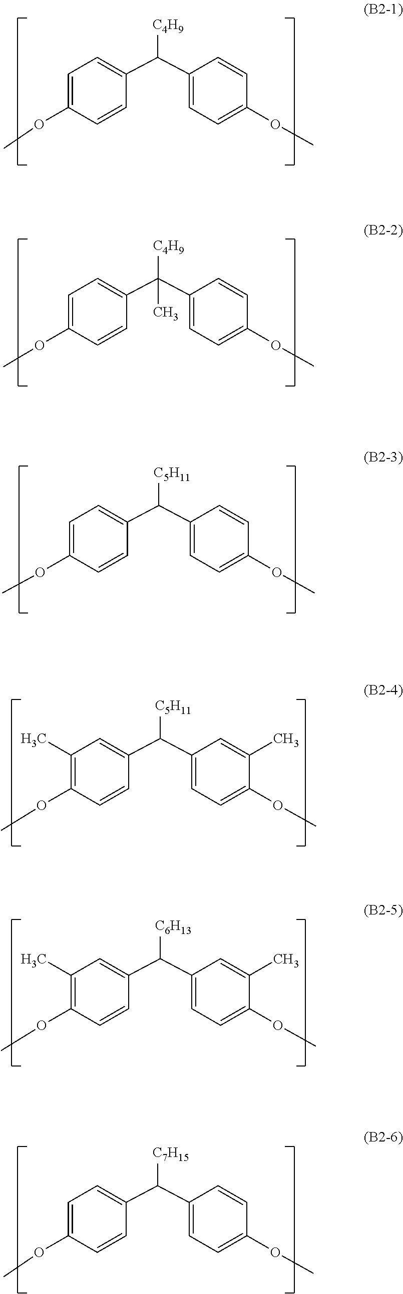

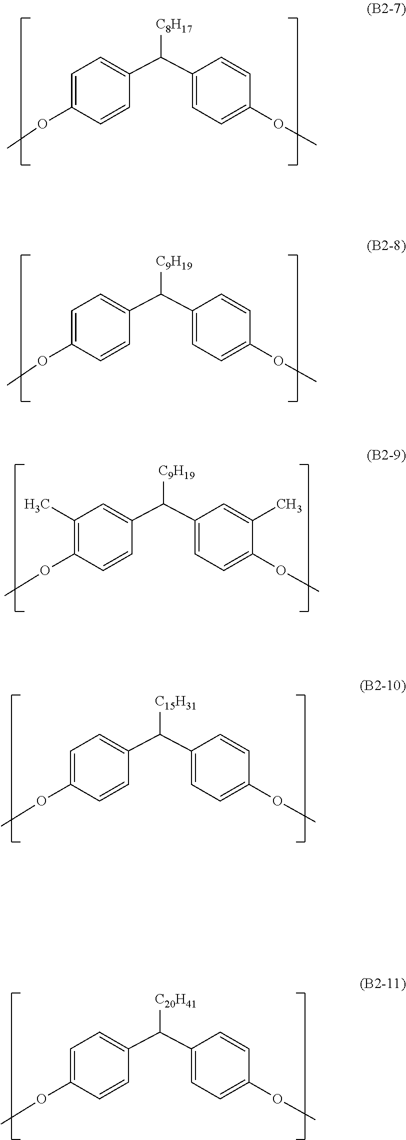

Hereinafter, diol units (B3-1) to (B3-4) are shown as specific examples of the diol unit (B3). The diol unit (B3) is not limited thereto.

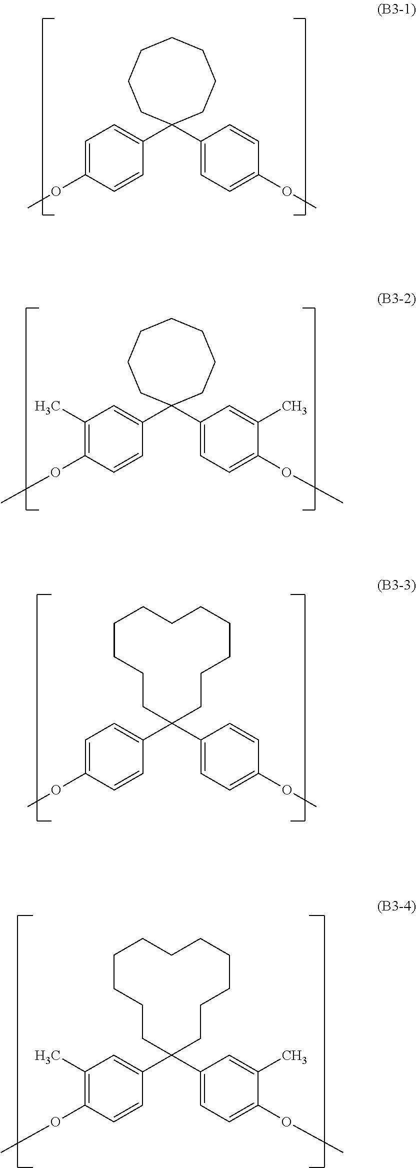

Hereinafter, diol units (B4-1) to (B4-7) are shown as specific examples of the diol unit (B4). The diol unit (B4) is not limited thereto.

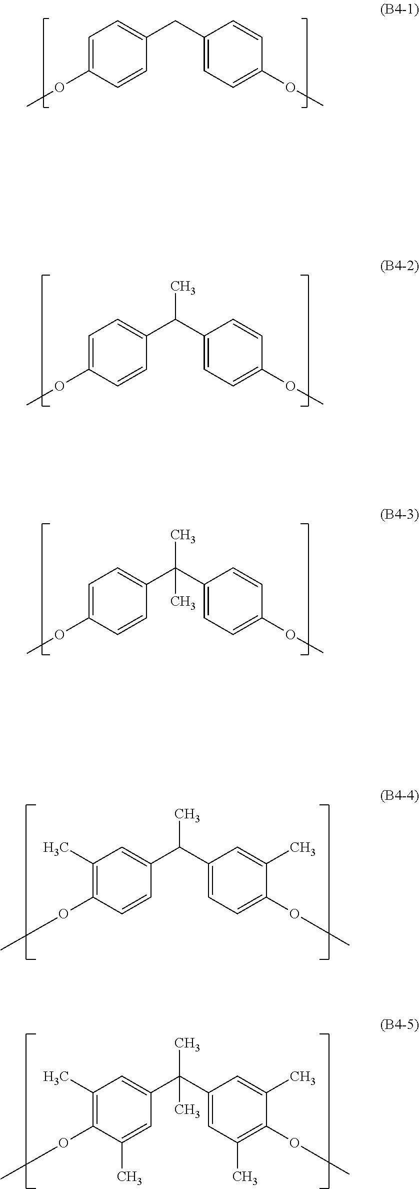

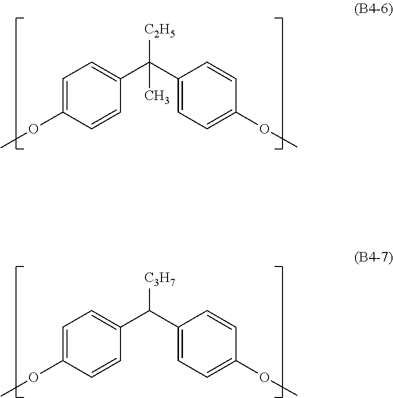

Hereinafter, diol units (B5-1) to (B5-6) are shown as specific examples of the diol unit (B5). The diol unit (B5) is not limited thereto.

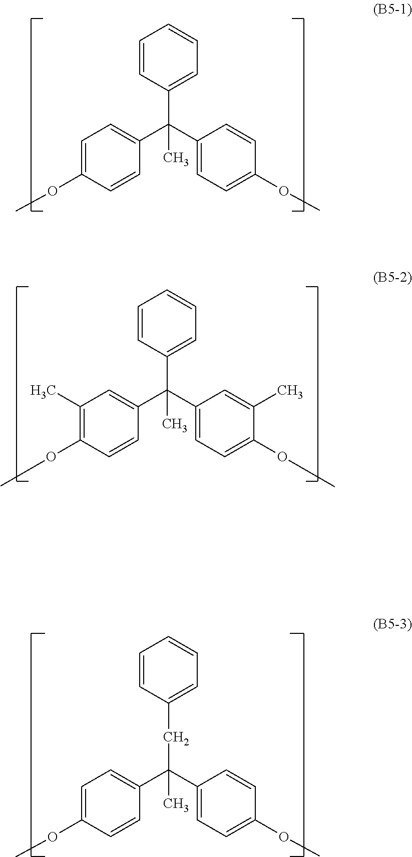

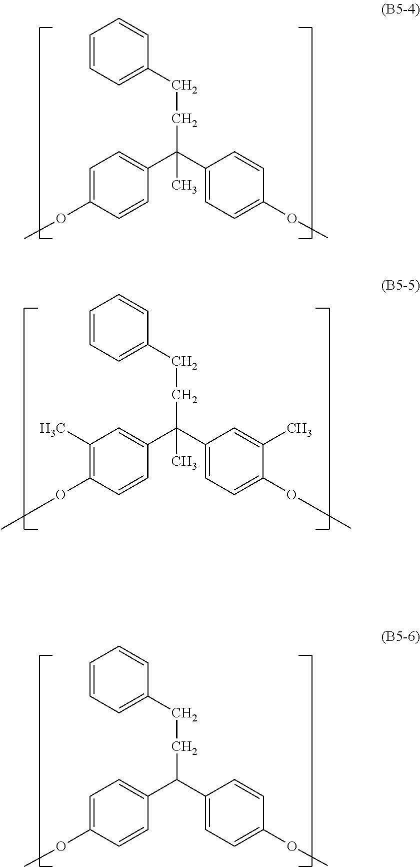

Hereinafter, diol units (B6-1) to (B6-4) are shown as specific examples of the diol unit (B6). The diol unit (B6) is not limited thereto.

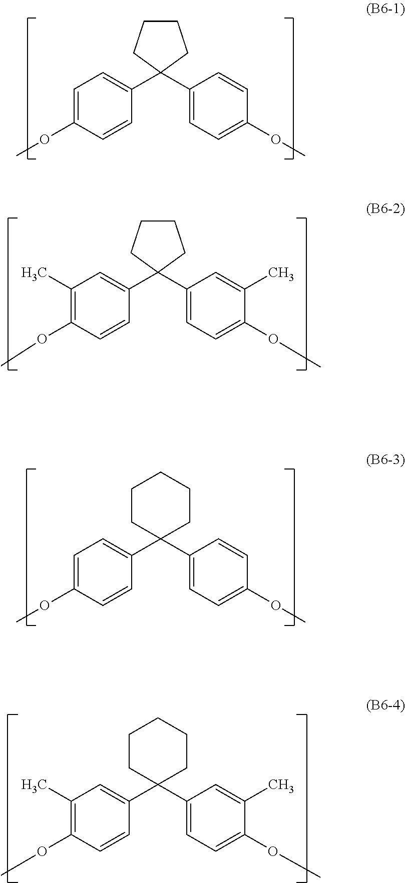

Hereinafter, diol units (B7-1) to (B7-3) are shown as specific examples of the diol unit (B7). The diol unit (B7) is not limited thereto.

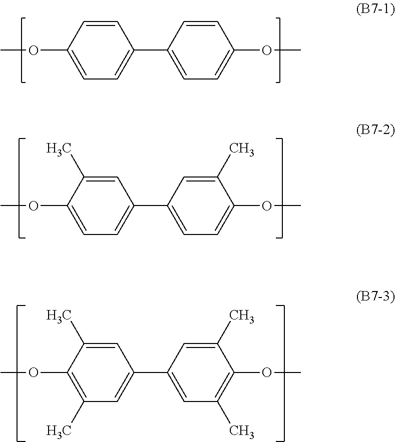

Hereinafter, diol units (B8-1) to (B8-3) are shown as specific examples of the diol unit (B8). The diol unit (B8) is not limited thereto.

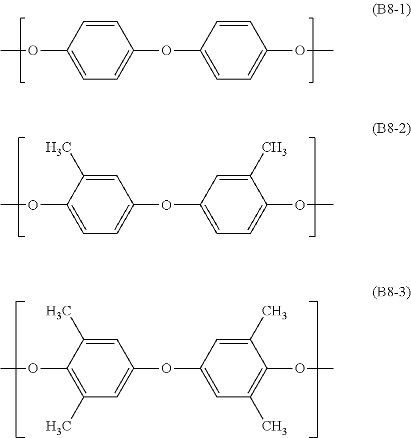

The diol unit (B) included in the polyarylate resin (PA) may be used alone or in combination of two or more kinds thereof.

A mass proportion of the diol unit (B) in the polyarylate resin (PA) is, for example, preferably 25% by mass or more and 80% by mass or less.

In a case where the mass proportion of the diol unit (B) is 25% by mass or greater, peeling of the outermost surface layer can be further suppressed. From the viewpoint, the mass proportion of the diol unit (B) is, for example, more preferably 30% by mass or greater and still more preferably 35% by mass or greater.

In a case where the mass proportion of the diol unit (B) is 80% by mass or less, the solubility in a coating solution for forming the outermost surface layer is maintained, and thus the abrasion resistance can be improved. From the viewpoint, the mass proportion of the diol unit (B) is, for example, more preferably 75% by mass or less and still more preferably 70% by mass or less.

The polyarylate resin (PA) may have other diol units in addition to the diol unit (B). Examples of other diol units include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. The diol units included in the polyarylate resin (PA) may be used alone or in combination of two or more kinds thereof.

A terminal of the polyarylate resin (PA) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The weight-average molecular weight of the polyarylate resin (PA) is, for example, preferably 30,000 or greater and 300,000 or less, more preferably 40,000 or greater and 250,000 or less, and still more preferably 50,000 or greater and 200,000 or less.

The molecular weight of the polyarylate resin (PA) is a molecular weight in terms of polystyrene measured by gel permeation chromatography (GPC). The GPC is carried out by using tetrahydrofuran as an eluent.

The polyarylate resin (PA) can be obtained by polycondensing a monomer providing the dicarboxylic acid unit (A), a monomer providing the diol unit (B), and other monomers as necessary using a method in the related art. Examples of the method of polycondensing monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B (JP-S40-1959B). Since the interfacial polymerization method enables the reaction to proceed faster than the reaction carried out by the solution polymerization method and also enables suppression of hydrolysis of the divalent carboxylic acid halide, as a result, a high-molecular-weight polyarylate resin (PA) can be obtained.

### Other Resins

The outermost surface layer may further contain a resin other than the polyarylate resin.

Examples of other resins include a polycarbonate resin, a polycarbonate resin, a polyester, a polyester resin other than the polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane.

Among the above, the outermost surface layer may further contain a polycarbonate resin.

In the aspect in which the polycarbonate resin is further contained, a fine phase separation structure is formed in the outermost surface layer. As a result, the surface roughness due to the coating film defects of the outermost surface layer is reduced.

As the polycarbonate resin, for example, a polycarbonate resin in which constitutional units having an aromatic ring are continuous is preferable. In the polycarbonate resin, resin molecules are bonded to each other by an intermolecular force due to stacking of aromatic rings, and thus the abrasion resistance of the outermost surface layer is improved. For example, preferred aspects of the polycarbonate resin include, specifically, the polycarbonate resin disclosed in JP2023-121553A. For example, a polycarbonate resin used in Examples described later is shown as a more preferred aspect of the polycarbonate resin. The polycarbonate resin may be used alone or in combination of two or more kinds thereof.

From the viewpoint of forming a fine phase separation structure in the outermost surface layer, a proportion of the polyarylate resin in a total amount of the polyarylate resin and the polycarbonate resin contained in the outermost surface layer of the photoreceptor is, for example, preferably 5% by mass or more and 95% by mass or less, more preferably 10% by mass or more and 90% by mass or less, and still more preferably 20% by mass or more and 80% by mass or less.

In a case where the outermost surface layer contains both a polyarylate resin and a polycarbonate resin, as a combination of the polyarylate resin and the polycarbonate resin, for example, it is preferable that at least one of the polyarylate resin or the polycarbonate resin has a constitutional unit containing a biphenyl represented by Formula (BP), and it is more preferable that both the polyarylate resin and the polycarbonate resin have a constitutional unit containing a biphenyl represented by Formula (BP).

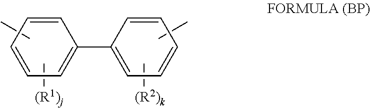

In Formula (BP), j is an integer of 0 or greater and 4 or less, j pieces of R's are each independently a methyl group or an ethyl group, k is an integer of 0 or greater and 4 or less, and k pieces of R²'s are each independently a methyl group or an ethyl group.

The biphenyl represented by Formula (BP) may be an entire structure or a part of a structure obtained by removing an ester bond (—C(═O)O—) or a carbonate bond (—OC(═O)O—) from the constitutional unit including the biphenyl represented by Formula (BP). In other words, the right end and the left end of the biphenyl represented by Formula (BP) may be each independently bonded to an ester bond or a carbonate bond directly or bonded to an ester bond or a carbonate bond via another atom or an atomic group.

j is an integer of 0 or greater and 4 or less, for example, preferably an integer of 0 or greater and 3 or less, more preferably an integer of 0 or greater and 2 or less, still more preferably 0 or 1, and particularly preferably 0.

In a case where j is an integer of 1 or greater, j pieces of R¹'s are each independently a methyl group or an ethyl group and, for example, preferably a methyl group.

k is an integer of 0 or greater and 4 or less, for example, preferably an integer of 0 or greater and 3 or less, more preferably an integer of 0 or greater and 2 or less, still more preferably 0 or 1, and particularly preferably 0.

In a case where k is an integer of 1 or greater, k pieces of R²'s are each independently a methyl group or an ethyl group and, for example, preferably a methyl group.

The biphenyl represented by Formula (BP) is, for example, preferably 4,4′-biphenyl with respect to a linking position in a main chain.

As a combination of the polyarylate resin and the polycarbonate resin, for example, a combination of a polyarylate resin having at least one of a dicarboxylic acid unit (A2-3) or a diol unit (B7-1) and a polycarbonate resin having a constitutional unit (Cb7-1) is particularly preferable.

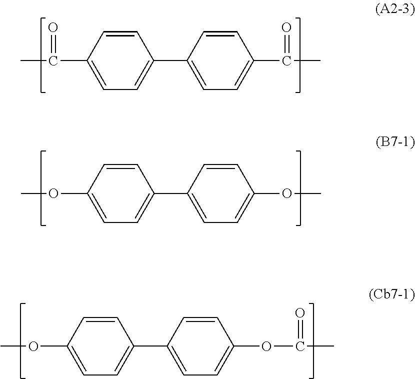

### Silicone Oil

Examples of the silicone oil include a silicone graft polymer, a silicone block polymer, a modified silicone oil, and a cyclic siloxane compound.

The content of the silicone oil in the outermost surface layer is 0.001 ppm or more and 15000.000 ppm or less, and for example, preferably 0.010 ppm or more and 10000.000 ppm or less and more preferably 10.000 ppm or more and 500.000 ppm or less. In the present specification, ppm is based on mass.

In a case where the content of the silicone oil is equal to or greater than the lower limit value, the polyarylate resin and the silicone oil are compatible with each other, and even in a case where the outermost surface layer is formed, components in the coating film are compatible with each other, and the local drying unevenness on the surface of the coating film is further suppressed. Therefore, the surface roughness due to the coating film defects such as the film thickness unevenness is reduced.

In a case where the content of the silicone oil is equal to or smaller than the upper limit value, even in a case where the outermost surface layer is formed, the coating solution is suppressed from being repelled from the surface of the photosensitive layer due to excessive silicone oil. As a result, the surface roughness due to coating film defects such as coating film unevenness is further reduced.

Examples of the silicone graft polymer include a silicone-grafted acrylic polymer and a silicone-grafted modified polyvinyl alcohol.

Examples of the silicone block polymer include a silicone block acrylic polymer and a silicone block-modified polyvinyl alcohol.

Examples of modified silicone oil include polyether modified polysiloxane, amino modified polysiloxane, epoxy modified polysiloxane, carboxyl modified polysiloxane, carbinol modified polysiloxane, fluorine modified polysiloxane, methacryl modified polysiloxane, mercapto modified polysiloxane, and phenol modified polysiloxane.

The cyclic siloxane compound preferably contains, for example, at least one selected from the group consisting of cyclic siloxane compounds represented by General Formulae (1), (2), (3), and (4). By including the cyclic siloxane compound represented by General Formulae (1), (2), (3), and (4), stress relaxation due to the cyclic siloxane skeleton is exhibited, and curing contraction of the outermost layer is likely to be relaxed. As a result, the surface roughness on the outer peripheral surface is further reduced.

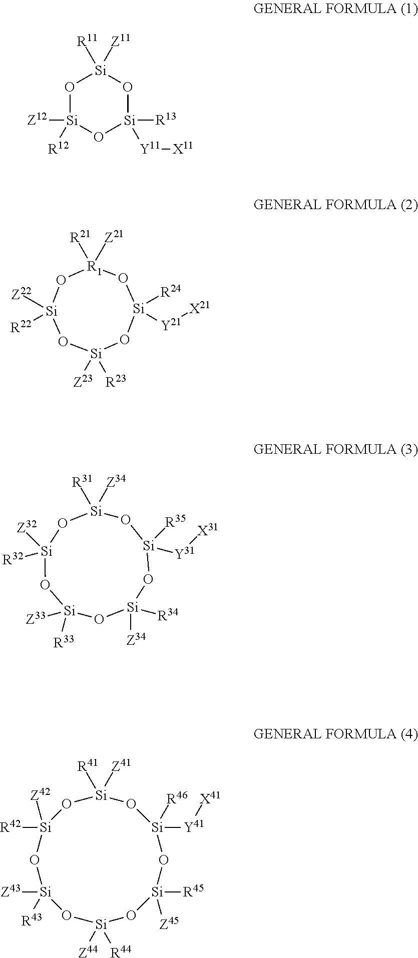

In General Formula (1), R¹¹, R¹², and R¹³ each independently represent a hydrogen atom or a monovalent alkyl group which may have a substituent. From the viewpoint of reducing the roughness on the outer peripheral surface of the photoreceptor, R¹¹, R¹², and R¹³ are, for example, each independently preferably a hydrogen atom or a monovalent alkyl group having 1 or more and 10 or less carbon atoms, which may have a substituent.

In General Formula (2), R²¹, R²², R²³ and R²⁴ each independently represent a hydrogen atom or a monovalent alkyl group which may have a substituent. From the viewpoint of reducing the roughness on the outer peripheral surface of the photoreceptor, R²¹, R²², R²³, and R²⁴ are, for example, each independently preferably a hydrogen atom or a monovalent alkyl group having 1 or more and 10 or less carbon atoms, which may have a substituent.

In General Formula (3), R³¹, R³², R³³, R³⁴, and R³⁵ each independently represent a hydrogen atom or a monovalent alkyl group which may have a substituent. From the viewpoint of reducing the roughness on the outer peripheral surface of the photoreceptor, R³¹, R³², R³³, R³⁴, and R³⁵ are, for example, each independently preferably a hydrogen atom or a monovalent alkyl group having 1 or more and 10 or less carbon atoms, which may have a substituent.

In General Formula (4), R⁴¹, R⁴², R⁴³, R⁴⁴, R⁴⁵, and R⁴⁶ each independently represent a hydrogen atom or a monovalent alkyl group which may have a substituent. From the viewpoint of reducing the roughness on the outer peripheral surface of the photoreceptor, for example, R⁴¹, R⁴², R⁴³, R⁴⁴, R⁴⁵, and R⁴⁶ are preferably each independently a hydrogen atom or a monovalent alkyl group having 1 or more and 10 or less carbon atoms, which may have a substituent.

In General Formulae (1), (2), (3), and (4), the monovalent alkyl group represented by R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ may have a substituent.

Examples of the unsubstituted alkyl group include a linear alkyl group having 1 or more and 20 or less carbon atoms (for example, preferably 1 or more and 10 or less carbon atoms and more preferably 1 or more and 6 or less carbon atoms), a branched alkyl group having 3 or more and 20 or less carbon atoms (for example, preferably 3 or more and 10 or less carbon atoms), and a cyclic alkyl group having 3 or more and 20 or less carbon atoms (for example, preferably 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Specific examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and the like, and a polycyclic (for example, bicyclic, tricyclic, or spirocyclic) alkyl group composed of these monocyclic alkyl groups linked to each other.

Among the above, for example, a linear alkyl group such as a methyl group and an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, and an iodine atom).

In General Formulae (1), (2), (3) and (4), Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent. Examples of the monovalent alkyl group that may have a substituent as Z¹, Z¹², Z²¹, Z²², Z²³, Z³¹, Z³², Z³³, Z³⁴, Z⁴¹, Z⁴², Z⁴³, Z⁴⁴, and Z⁴⁵ are the same as the monovalent alkyl group that may have a substituent as R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶.

In General Formulae (1), (2), (3), and (4), X¹, X¹², X²¹, X³¹, and X⁴¹ each independently represent a monovalent functional group selected from the group consisting of a succinic anhydride group, a (meth)acrylic group, an alicyclic epoxy group, an amino group, a hydroxyl group, and a glycidyl group.

In the present specification, the succinic anhydride group, the amino group, the hydroxyl group, and the glycidyl group each have the structures shown below.

In the present specification, the (meth)acrylic group denotes an acrylic group or a methacrylic group, and each of the acrylic group and the methacrylic group has the structure shown below.

The alicyclic epoxy group is not limited as long as the alicyclic epoxy group is a monovalent group having an alicyclic structure and an epoxy group, and examples thereof include an alicyclic epoxy group (1) shown below. Further, examples thereof include, in addition to the following alicyclic epoxy group (1), an alicyclic epoxy group having an alicyclic structure with 3 or more and 20 or less carbon atoms, and the alicyclic epoxy group may have an epoxy group in any place of the alicyclic structure.

Further, the monovalent groups shown below are linked at sites of “*”.

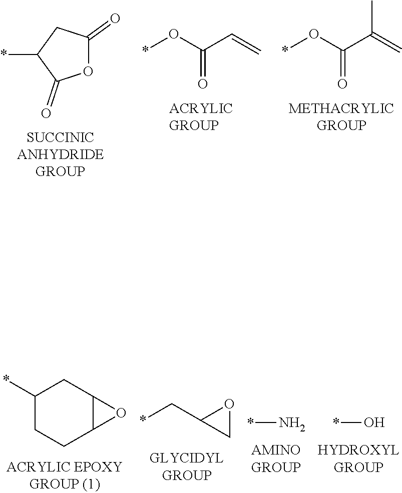

In General Formulae (1), (2), (3), and (4), from the viewpoint of reducing the roughness of the outer peripheral surface of the photoreceptor, it is preferable that X¹¹, X¹², X²¹, X³¹, and X⁴¹ each independently represent, for example, a monovalent functional group selected from the group consisting of a succinic anhydride group, a (meth)acrylic group, and an amino group.

In General Formulae (1), (2), (3), and (4), Y¹¹, Y¹², Y²¹, Y³¹, and Y⁴¹ each independently represent a divalent organic linking group. Further, the organic linking group denotes a divalent group having carbon atoms. Examples of the divalent organic linking group include a divalent alkyl group that may have a substituent. Examples of the divalent alkyl group that may have a substituent as Y¹¹, Y¹², Y²¹, Y³¹, and Y⁴¹ include a divalent group obtained by removing one hydrogen atom from a monovalent alkyl group that may have a substituent as R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶. Further, from the viewpoint of reducing the roughness of the outer peripheral surface of the photoreceptor, for example, it is preferable that Y¹¹, Y¹², Y²¹, Y³¹, and Y⁴¹ are each independently a divalent organic linking group represented by —(CH₂)ₙ— (for example, here, n represents preferably 1 or greater or 8 or less and more preferably 1 or greater and 6 or less).

From the viewpoint of further reducing the surface roughness of the outer peripheral surface of the photoreceptor, for example, it is preferable that the cyclic siloxane compound represented by General Formula (2) contains two or four functional groups, that is, it is preferable that one or three of Z²¹, Z²², and Z²³ are groups represented by —Y¹²—X¹². Further, for example, it is preferable that the cyclic siloxane compound represented by General Formula (2) contains two functional groups. That is, it is more preferable that Z²² is a group represented by —Y¹²—X¹² and Z²¹ and Z²³ are a hydrogen atom or a monovalent alkyl group. Specific Examples of Cyclic Siloxane Compound

Preferred specific examples of the cyclic siloxane compound are shown in the table below, but the present exemplary embodiment is not limited thereto. In the following exemplary compounds, R¹¹, R¹², R¹³, and R's each independently represent a hydrogen atom or a monovalent alkyl group which may have a substituent, and n is 1 or more and 6 or less. Further, Z¹² represents an alkylene group substituted by X—(CH₂)ₙ—.

In the following structures, the monovalent group represented by X is a succinic anhydride group, an acrylic group, a methacrylic group, an alicyclic epoxy group (1), an amino group, a hydroxyl group, and a glycidyl group, each of which has the above-described structure.

TABLE 1

| No. | Structure | X |
|---|---|---|
| 1 | (1) | Succinic anhydride |
| 2 | | Acrylic group |
| 3 | | Methacrylate group |
| 4 | | Alicyclic epoxy group (1) |
| 5 | | Glycidyl group |
| 6 | | Amino group |
| 7 | | Hydroxyl group |
| 8 | (2-1) | Succinic anhydride |
| 9 | | Acrylic group |
| 10 | | Methacrylate group |
| 11 | | Alicyclic epoxy group (1) |
| 12 | | Glycidyl group |
| 13 | | Amino group |
| 14 | | Hydroxyl group |
| 15 | (2-2) | Succinic anhydride |
| 16 | | Acrylic group |
| 17 | | Methacrylate group |
| 18 | | Alicyclic epoxy group (1) |
| 19 | | Glycidyl group |
| 20 | | Amino group |
| 21 | | Hydroxyl group |
| 22 | (3) | Succinic anhydride |
| 23 | | Acrylic group |
| 24 | | Methacrylate group |
| 25 | | Alicyclic epoxy group (1) |
| 26 | | Glycidyl group |
| 27 | | Amino group |
| 28 | | Hydroxyl group |
| 29 | (4) | Succinic anhydride |
| 30 | | Acrylic group |
| 31 | | Methacrylate group |
| 32 | | Alicyclic epoxy group (1) |
| 33 | | Glycidyl group |
| 34 | | Amino group |
| 35 | | Hydroxyl group |

(1) 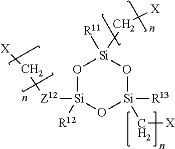
(2-1) 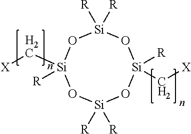
(2-2) 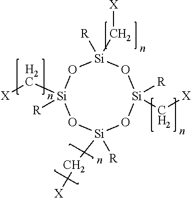
(3) 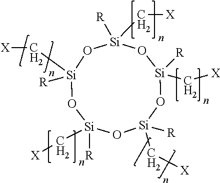
(4)

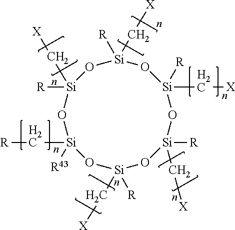

Among the above, as the silicone oil, for example, it is preferable to include at least one selected from the group consisting of a silicone graft polymer, a modified silicone oil, and a cyclic siloxane compound, it is more preferable to include at least one selected from the group consisting of a silicone-grafted acrylic polymer, an ether-modified polysiloxane, and a cyclic siloxane compound, and it is still more preferable to include at least one of an ether-modified polysiloxane or a silicone-grafted acrylic polymer.

In a case where the silicone oil includes at least one selected from the above-described group, the affinity between the polyarylate resin and the silicone oil is more excellent, and even in a case of forming the outermost surface layer, the components in the coating film are compatible with each other, and the local drying unevenness on the surface of the coating film is further suppressed. Therefore, the surface roughness due to the coating film defects such as the film thickness unevenness is reduced.

### Characteristics of Outermost Surface Layer

In the outermost surface layer of the photoreceptor, for example, a proportion of the fluororesin particles in the layer is preferably 5% by mass or less, more preferably 1% by mass or less, and still more preferably 0% by mass (that is, the outermost surface layer does not contain the fluororesin particles).

Since there is a high possibility that the regulations on manufacturing and use of the organic fluorine compounds are strengthened in the future, for example, a content of the fluororesin particles is preferably within the above-described range.

A layer thickness of the outermost surface layer may be set according to a function of the layer.

In a case where the charge transport layer is the outermost surface layer, the layer thickness of the outermost surface layer is, for example, preferably 5 μm or more and 50 μm or less, more preferably 8 μm or more and 45 μm or less, and still more preferably 10 μm or more and 40 μm or less.

In a case where the single layer-type photosensitive layer is the outermost surface layer, the layer thickness of the outermost surface layer is, for example, preferably 5 μm or more and 50 μm or less, more preferably 8 μm or more and 45 μm or less, and still more preferably 10 μm or more and 40 μm or less.

A method of forming the outermost surface layer is the same as a method of forming the charge transport layer and a method of forming the single layer-type photosensitive layer, which will be described later.

Hereinafter, each layer of the photoreceptor will be described in detail.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and the roughening is suitable for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. The film thickness of the coating film is, for example, preferably 0.3 μm or greater and m or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. A film thickness of the coating film is, for example, preferably 0.1 m or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, the silane coupling agent having an amino group and other silane coupling agents may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound such as 4-hydroxybenzophenone or 2,3,4-trihydroxybenzophenone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, 4-ethoxy-1,2-hydroxy-9,10-anthraquinone, or a derivative thereof is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that the electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and is preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additive include known materials such as an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

For example, the surface roughness (ten-point average roughness) of the undercoat layer may be adjusted to ½ from 1/(4n) (n is a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The layer thickness of the undercoat layer is set to be, for example, preferably 15 μm or greater and more preferably in a range of 20 μm or greater and 50 μm or less.

### Interlayer

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical methods such as a dip coating method, a push-up coating method, a wire bar coating method, a spray coating method, a blade coating method, an air knife coating method, and a curtain coating method.

The layer thickness of the interlayer is set to be, for example, preferably in a range of 0.1 μm or greater and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is preferable in a case where an incoherent light source such as a light emitting diode (LED) and an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more. These binder resins are used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a fine flow path in a high-pressure state. During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The layer thickness of the charge generation layer is set to be, for example, preferably in a range of 0.1 μm or greater and 5.0 μm or less and more preferably in a range of 0.2 μm or greater and 2.0 μm or less.

### Charge Transport Layer

In a case where the photoreceptor according to the present exemplary embodiment includes a lamination-type photosensitive layer, the charge transport layer is the outermost surface layer. In this case, the charge transport layer contains a charge transport material, a polyarylate resin, and silicone oil, in which a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. These charge transport materials are used alone or in combination of two or more kinds thereof, but are not limited thereto.

Examples of the polymer charge transport material include known chemical substances having charge transport properties, such as poly-N-vinylcarbazole and polysilane. For example, a polyester-based polymer charge transport material is preferable. The polymer charge transport material may be used alone or in combination with a binder resin.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin containing a group derived from these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of the charge mobility, for example, it is preferable that the charge transport material contains at least one selected from the group consisting of a chemical substance (C1) represented by Formula (C1), a chemical substance (C2) represented by Formula (C2), a chemical substance (C3) represented by Formula (C3), and a chemical substance (C4) represented by Formula (C4).

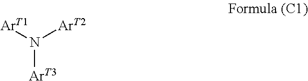

In Formula (C1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. In a case where R^{T5} and R^{T6} are aryl groups, the aryl groups may be linked through a divalent group of —C(R⁵¹)(R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

The group in Formula (C1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the chemical substance (C1), for example, a chemical substance containing at least one of an aryl group or —C₆H₄—CH═CH—CH═C(R^{T7})(R^{T8}) is preferable, and a chemical substance (C′1) represented by Formula (C′1) is more preferable.

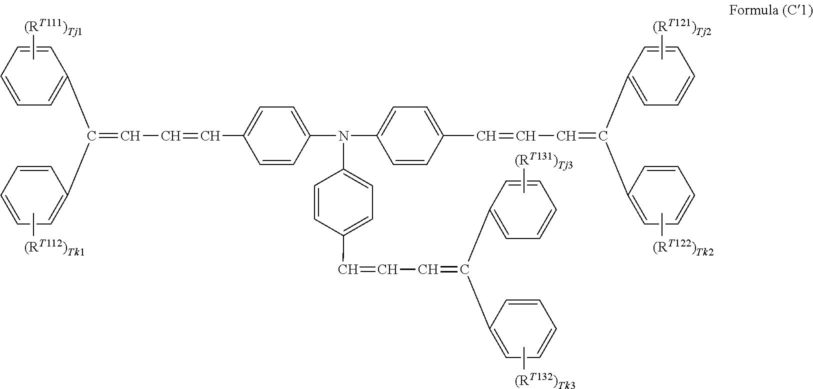

In Formula (C′1), R^{T111}, R^{T112}, R^{T121}, R^{T122}, R^{T131}, and R^{T132} are each independently a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

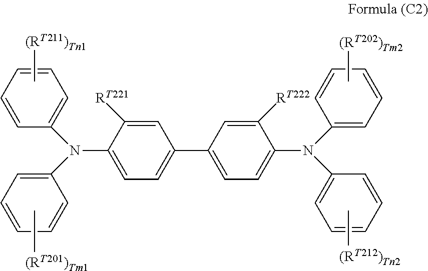

In Formula (C2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

The group in Formula (C2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the chemical substance (C2), for example, a chemical substance containing at least one of an alkyl group, an aryl group, or —CH═CH—CH═C(R^{T24})(R^{T25}) is preferable, and a chemical substance containing two of an alkyl group, an aryl group, or —CH═CH—CH═C(R^{T24})(R^{T25}) is more preferable.

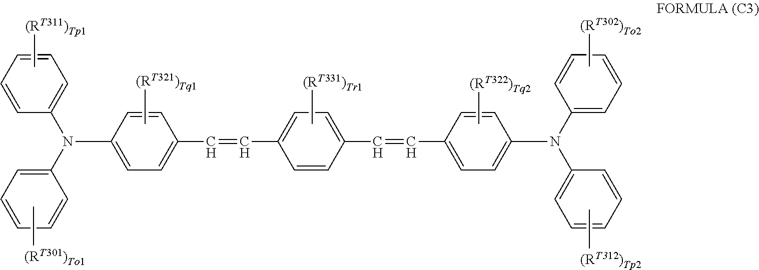

In Formula (C3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}). R^{T31}, R^{T32}, R^{T33}, R^{T34}, and R^{T35} are each independently a hydrogen atom, an alkyl group, or an aryl group. R^{T321}, R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr are each independently 0, 1, or 2.

The group in Formula (C3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

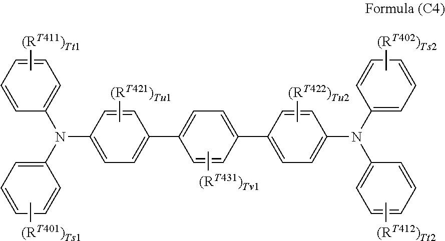

In Formula (C4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}, R^{T44} and R^{T45} are each independently a hydrogen atom, an alkyl group, or an aryl group. R^{T421}, R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

The group in Formula (C4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The content of the charge transport material contained in the charge transport layer is, for example, preferably 20% by mass or greater and 70% by mass or less with respect to the total mass of the charge transport layer.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins are used alone or in combination of two or more kinds thereof.

A blending ratio between the charge transport material and the binder resin is, for example, preferably 10:1 to 1:5 in terms of mass ratio.

In a case where the charge transport layer is the outermost surface layer of the photoreceptor, the charge transport layer contains a polyarylate resin (PA) and a polycarbonate resin. As a combination of the polyarylate resin (PA) and the polycarbonate resin, for example, a combination of resins each having a constitutional unit containing a biphenyl represented by Formula (BP) is preferable.

From the viewpoint of forming a fine phase separation structure in the charge transport layer, a proportion of the polyarylate resin (PA) in a total amount of the polyarylate resin (PA) and the polycarbonate resin contained in the charge transport layer is, for example, preferably 5% by mass or more and 95% by mass or less, more preferably 10% by mass or more and 90% by mass or less, and still more preferably 20% by mass or more and 80% by mass or less.

The charge transport layer may also contain other known additives.

The formation of the charge transport layer is not particularly limited, and a known formation method is used. For example, the charge transport layer is obtained by forming a coating film of a coating solution for forming a charge transport layer, which is obtained by adding the above-described components to a solvent, drying the coating film, and heating the coating film as necessary.

Examples of the solvent for preparing the coating solution for forming the charge transport layer include typical organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

The layer thickness of the charge transport layer is, for example, preferably 5 μm or more and 50 μm or less, more preferably 8 μm or more and 45 μm or less, and still more preferably 10 μm or more and 40 μm or less.

### Single Layer-Type Photosensitive Layer

The single layer-type photosensitive layer (charge generation/charge transport layer) is, for example, a layer containing a charge generation material, a charge transport material, and as necessary, a binder resin and other known additives. These materials are the same as the materials described in the sections of the charge generation layer and the charge transport layer.

The content of the charge generation material in the single layer-type photosensitive layer may be, for example, 0.1% by mass or greater and 10% by mass or less and is preferably 0.8% by mass or greater and 5% by mass or less with respect to the total solid content. In addition, a content of the charge transport material in the single layer-type photosensitive layer may be, for example, 5% by mass or more and 50% by mass or less with respect to the total solid content.

The method of forming the single layer-type photosensitive layer is the same as the method of forming the charge generation layer or the charge transport layer.

The layer thickness of the single layer-type photosensitive layer is, for example, preferably 5 μm or more and 50 μm or less, more preferably 8 μm or more and 45 μm or less, and still more preferably 10 μm or more and 40 μm or less.

In a case where the single layer-type photosensitive layer is the outermost surface layer of the photoreceptor, the single layer-type photosensitive layer contains a charge transport material, a polyarylate resin, and silicone oil, in which a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

The single layer-type photosensitive layer contains a polyarylate resin (PA) and a polycarbonate resin. As a combination of the polyarylate resin (PA) and the polycarbonate resin, for example, a combination of resins each having a constitutional unit containing a biphenyl represented by Formula (BP) is preferable.

From the viewpoint of forming a fine phase separation structure in the single layer-type photosensitive layer, a proportion of the polyarylate resin (PA) in a total amount of the polyarylate resin (PA) and the polycarbonate resin contained in the single layer-type photosensitive layer is, for example, preferably 20% by mass or more and 80% by mass or less, more preferably 25% by mass or more and 75% by mass or less, and still more preferably 30% by mass or more and 70% by mass or less.

### Image Forming Apparatus and Process Cartridge

The image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing device that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a charge erasing device that erases the charges on the surface of the electrophotographic photoreceptor by applying the charge erasing light after the transfer of the toner image and before the charging; and an apparatus including an electrophotographic photoreceptor heating member for increasing the temperature of the electrophotographic photoreceptor and decreasing the relative temperature are employed.

In a case of the intermediate transfer-type apparatus, for example, the transfer device has a configuration including an intermediate transfer member with a surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

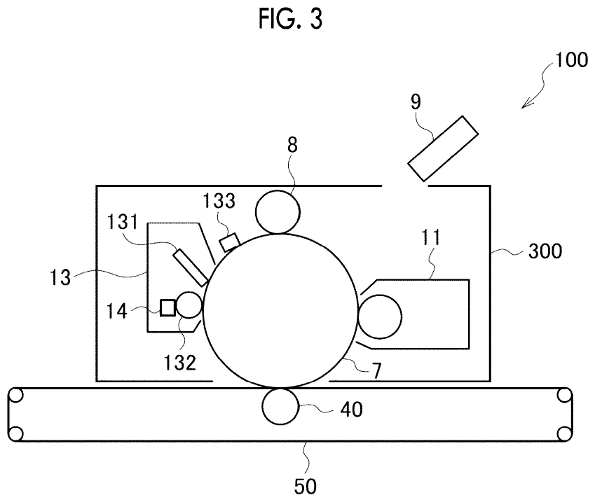

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and a cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

The charging device 8 may be a contact type charging device in which the charging member is in contact with the outer peripheral surface of the photoreceptor, or may be a non-contact type charging device in which the charging member is not in contact with the outer peripheral surface of the photoreceptor. An effect (the contamination of the charging member is unlikely to occur for a long period of time) obtained by the image forming apparatus according to the present exemplary embodiment is remarkable in the contact type charging device.

As the charging device 8, for example, a contact-type charging member formed of a conductive or semi-conductive charging roller, a charging brush, a charging film, a charging rubber blade, a charging tube, or the like is used. Further, known chargers such as a non-contact type roller charger, a scorotron charger using corona discharge, and a corotron charger are also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include transfer chargers known per se such as a contact-type transfer charger formed of a belt, a roller, a film, and a rubber blade, a scorotron transfer charger using corona discharge, and a corotron transfer charger.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

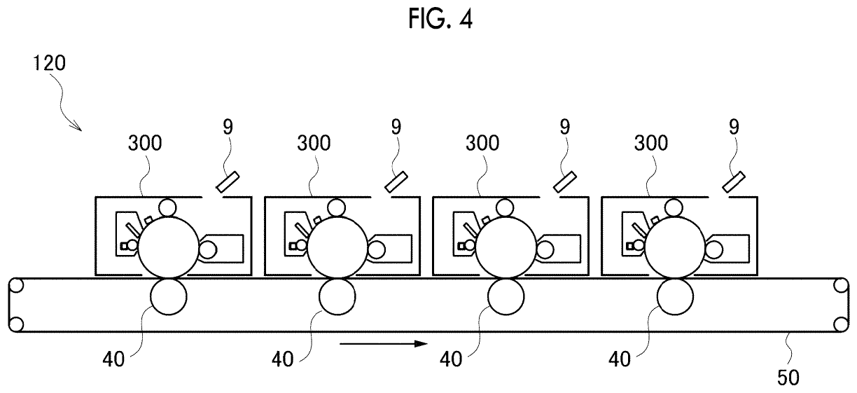

FIG. 4 is a schematic configuration view showing an example of an image forming apparatus according to the present exemplary embodiment.

An image forming apparatus 120 shown in FIG. 4 is a tandem type multicolor image forming apparatus in which four process cartridges 300 are mounted. The image forming apparatus 120 is configured such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the treatment, the production, and the like are carried out at room temperature (25° C.±3° C.) unless otherwise specified.

### Synthesis of Polyarylate Resin

Polyarylate resins (PA1) to (PA7) are synthesized.

Table 2 shows units and compositions constituting the polyarylate resins.

A2-3 and the like listed in Table 2 are specific examples of the dicarboxylic acid unit (A) described above.

B1-2 and the like listed in Table 2 are specific examples of the diol unit (B) described above.

TABLE 2

| | Polyarylate resin | | | | | | | | |
|---|---|---|---|---|---|---|---|---|---|
| | Dicarboxylic unit (A) | | | | Diol unit (B) | | | | Mw |
| Number | Number | Mol % | Number | Mol % | Number | Mol % | Number | Mol % | k |
| PA1 | A2-3 | 50 | — | — | B1-2 | 50 | — | — | 110 |
| PA2 | A3-2 | 50 | — | — | B4-4 | 50 | — | — | 120 |
| PA3 | A3-2 | 25 | A4-3 | 25 | B4-6 | 50 | — | — | 115 |
| PA4 | A3-2 | 25 | A4-3 | 25 | B6-4 | 50 | — | — | 120 |
| PA5 | A3-2 | 25 | A4-3 | 25 | B4-4 | 50 | — | — | 125 |
| PA6 | A2-3 | 50 | — | — | B1-4 | 50 | — | — | 110 |
| PA7 | A3-2 | 50 | — | — | B3-4 | 50 | — | — | 120 |

### Production of Photoreceptor

As a material forming the outermost surface layer (charge transport layer), the following materials are prepared in addition to the polyarylate resin.
Charge transport material CTM-1
Charge transport material CTM-2

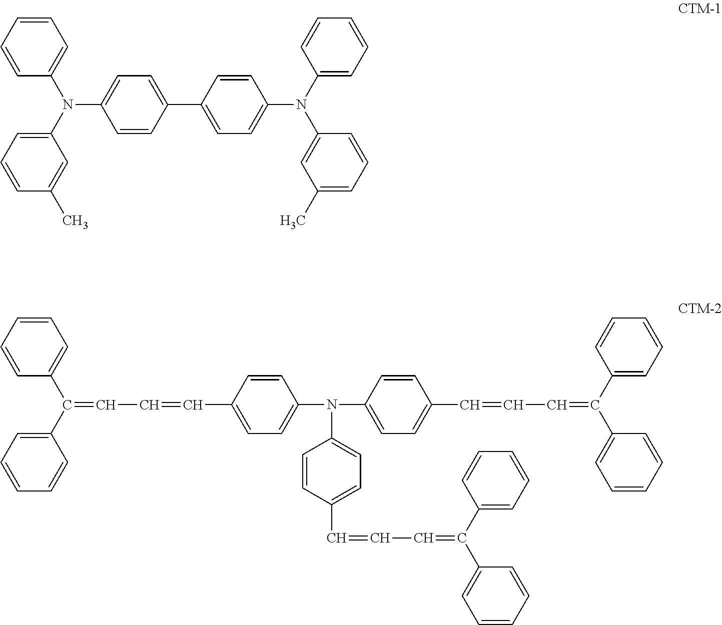 [SMILES: Cc1cccc(N(c2ccccc2)c2ccc(-c3ccc(N(c4ccccc4)c4cccc(C)c4)cc3)cc2)c1 ; C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Polycarbonate resin (PC1), viscosity average molecular weight: 50000
Polycarbonate resin (PC2), viscosity average molecular weight: 45000
Polycarbonate resin (PC3), viscosity average molecular weight: 40000

In the following structures, the numbers outside the parentheses of the polycarbonate resin (PC1) and the polycarbonate resin (PC2) indicate the molar ratios.

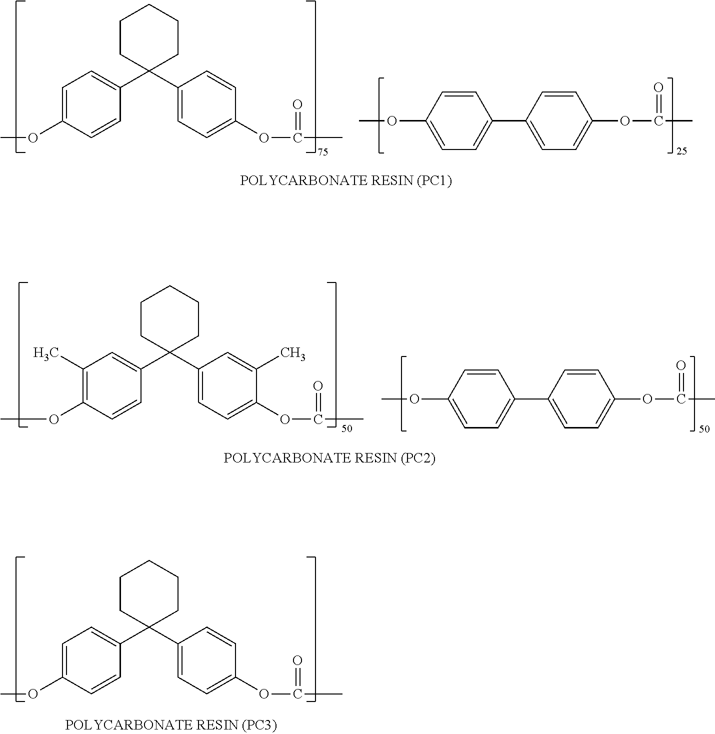

Silicone oil (KL700): silicone graft polymer “KL700” manufactured by Kyoeisha Chemical Co., Ltd.
Silicone oil (KP340): ether-modified silicone oil “KP340” manufactured by Shin-Etsu Chemical Co., Ltd.
Silicone oil (KF96): dimethyl silicone oil “KF96” manufactured by Shin-Etsu Chemical Co., Ltd.
Cyclic siloxane compound (1): Specific example No. 1 of cyclic siloxane compound represented by Formula (1) (X=succinic anhydride, number of X's=2, R=methyl group, n=1)
Cyclic siloxane compound (2): Specific example No. 8 of cyclic siloxane compound represented by Formula (2) (X=succinic anhydride, number of X's=4, R=methyl group, n=1)
Cyclic siloxane compound (3): Specific example No. 22 of cyclic siloxane compound represented by Formula (3) (X=acrylic group, number of X's=4, R=methyl group, n=1)
Cyclic siloxane compound (4): Specific example No. 29 of cyclic siloxane compound represented by Formula (4) (X=acrylic group, number of X's=2, R=methyl group, n=1)

### Example A1

### Formation of Undercoat Layer

3.5 parts of a butyral resin (trade name: S-LEC BM-1, manufactured by Sekisui Chemical Co., Ltd.) and 41 parts of methyl ethyl ketone are mixed and dissolved. 10 parts of a curing agent (blocked isocyanate, trade name: SUMIDUR 3175, Sumitomo Bayer Urethane Co., Ltd.), 45.5 parts of zinc oxide (trade name: SMZ-017N, TAYCA Corporation, Ltd.) surface-treated with a silane coupling agent (trade name: KBM603, Shin-Etsu Chemical Co., Ltd.), and 0.27 parts of the following compound are added and stirred, and then the mixture is dispersed for 2 hours with a sand mill using glass beads having a diameter of 1 mm. Further, 0.01 parts of dioctyl tin dilaurate and 2 parts of silicone resin particles (trade name: Tospearl 145, GE Toshiba Silicones) are added thereto and stirred, thereby obtaining a coating solution for forming an undercoat layer. The outer peripheral surface of the conductive substrate is coated with the coating solution for forming an undercoat layer by dip coating, and dried and cured at 170° C. for 40 minutes to form an undercoat layer with a layer thickness of 20 m.

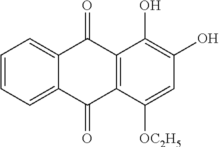 [SMILES: CCOc1cc(O)c(O)c2c1C(=O)c1ccccc1C2=O]

### Formation of Charge Generation Layer

A mixture consisting of 15 parts of hydroxygallium phthalocyanine as a charge generation material (having diffraction peaks at positions where Bragg angles (2θ+0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped and coated with the coating solution for forming a charge generation layer, and dried at room temperature to form a charge generation layer having a layer thickness of 0.25 m.

### Formation of Charge Transport Layer

Charge transport material: CTM-1 . . . 47 parts
Charge transport material: CTM-2 . . . 20 parts
Resin: polyarylate resin (PA1) . . . 94 parts (100% of total resin)
Silicone oil (KF96) . . . proportion shown in Table 3
Solvent: tetrahydrofuran . . . 570 parts
Solvent: toluene . . . 57 parts

The above-described materials are stirred and mixed to obtain a coating solution for forming a charge transport layer. The charge generation layer is dipped and coated with the coating solution for forming a charge transport layer, and dried at 143° C. for 30 minutes to form a charge transport layer having a layer thickness of 33 m. In this way, a photoreceptor A1 is obtained.

### Examples A2 to A11, Examples A30 to A36, and Comparative Examples A1 to A5

Each photoreceptor is produced in the same manner as in Example 1, except that the type and amount of each material in the charge transport layer are changed as shown in Table 3.

### Examples A12 to A29

Each photoreceptor is obtained in the same manner as in Example 1, except that the composition of the charge transport layer is changed as below and the type and amount of each material in the charge transport layer are changed as shown in Table 4.
Charge transport material: CTM-1 . . . 71 parts
Resin: polyarylate resin (PA1) . . . 94 parts (100% of total resin)
Silicone oil (KP340) . . . proportion shown in Table 3
Solvent: tetrahydrofuran . . . 570 parts
Solvent: toluene . . . 57 parts

The above-described materials are stirred and mixed to obtain a coating solution for forming a charge transport layer. The charge generation layer is dipped and coated with the coating solution for forming a charge transport layer, and dried at 143° C. for 30 minutes to form a charge transport layer having a layer thickness of 33 m. In this way, the photoreceptor is obtained.

### Example B1

The formation of the undercoat layer to the formation of the charge generation layer is carried out according to the same specifications as in Example A1.

### Formation of Charge Generation Layer

A mixture consisting of 15 parts of hydroxygallium phthalocyanine as a charge generation material (having diffraction peaks at positions where Bragg angles (2θ+0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped and coated with the coating solution for forming a charge generation layer, and dried at room temperature to form a charge generation layer having a layer thickness of 0.25 m.

### Formation of Charge Transport Layer

Charge transport material: CTM-1 . . . 47 parts
Charge transport material: CTM-2 . . . 20 parts
Resin: polyarylate resin (PA1) . . . 58 parts (60% of total resin)
Resin: polycarbonate resin (PC1) . . . 38 parts (40% of total resin)
Silicone oil (KF96) . . . proportion shown in Table 4
Solvent: tetrahydrofuran . . . 570 parts
Solvent: toluene . . . 57 parts

The above-described materials are stirred and mixed to obtain a coating solution for forming a charge transport layer. The charge generation layer is dipped and coated with the coating solution for forming a charge transport layer, and dried at 143° C. for 30 minutes to form a charge transport layer having a layer thickness of 33 m. In this way, a photoreceptor B1 is obtained.

### Examples B2 to B11, Examples B30 to B37, and Comparative Examples B1 to B5

Each photoreceptor is produced in the same manner as in Example 1, except that the type and amount of each material in the charge transport layer are changed as shown in Table 4.

### Examples B12 to B29

Each photoreceptor is obtained in the same manner as in Example 1, except that the composition of the charge transport layer is changed as below and the type and amount of each material in the charge transport layer are changed as shown in Table 4.
Charge transport material: CTM-1 . . . 71 parts
Resin: polyarylate resin (PA1) . . . 28 parts (30% of total resin)
Resin: polycarbonate resin (PC1) . . . 66 parts (70% of total resin)
Silicone oil (KP340) . . . proportion shown in Table 4
Solvent: tetrahydrofuran . . . 570 parts
Solvent: toluene . . . 57 parts

The above-described materials are stirred and mixed to obtain a coating solution for forming a charge transport layer. The charge generation layer is dipped and coated with the coating solution for forming a charge transport layer, and dried at 143° C. for 30 minutes to form a charge transport layer having a layer thickness of 33 m. In this way, the photoreceptor is obtained.

A proportion of the resin shown in Tables 3 and 4 is a mass proportion with respect to a total amount of the polyarylate resin and the polycarbonate resin.

### Evaluation of Surface Roughness

The surface roughness Ra (arithmetic average surface roughness Ra) is measured as follows.

For the electrophotographic photoreceptor of each example, a part of the outermost surface layer is cut out with a cutter or the like to acquire a measurement sample. The surface roughness Ra is measured for this measurement sample using a stylus type surface roughness measuring instrument (SURFCOM 1400A: manufactured by Tokyo Seimitsu Co., Ltd.). The measurement is performed in conformity with JIS B 0601-1994 under measurement conditions of an evaluation length Ln of 42.5 mm, a reference length L of 0.8 mm, and a cutoff value of 0.008 mm. The obtained surface roughness is evaluated according to the following standards.

### Evaluation Standard

S: The surface roughness Ra is less than 2 nm.

A: The surface roughness Ra is 2 nm or more and less than 3 nm.

B: The surface roughness Ra is 3 nm or more and less than 4 nm.

C: The surface roughness Ra is 4 nm or more and less than 5 nm.

D: The surface roughness Ra is 5 nm or more, which is an unacceptable level.

### Evaluation of Surface Repulsion

The surface repulsion is evaluated as follows.

Regarding the electrophotographic photoreceptor of each example, the form of the outermost surface layer is visually observed, and the surface repulsion is evaluated according to the following standard.

### Evaluation Standard

S: No coating film defects are observed by visual observation.

A: 1 or more and 2 or less coating film defects of 0.5 mm or less are observed, but the coating film defects are in an allowable range.

B: 1 or more and 3 or less coating film defects of 0.5 mm or more and less than 1 mm are observed, but the coating film defects are in an allowable range.

C: Coating film defects at a level at which the base (charge generation layer) is exposed are observed by visual observation, but the coating film defects are in an allowable range.

D: Coating film of the outermost surface layer cannot be formed, which is an unacceptable level.

A proportion of the resin shown in Tables 3 and 4 is a mass proportion with respect to a total amount of the polyarylate resin and the polycarbonate resin.

TABLE 3

| | Outermost surface layer | | | | | | | |
|---|---|---|---|---|---|---|---|---|
| | | | | | Charge transport material | | | |
| | | Residual | | | CTM-1 | CTM-2 | | |
| | | amount of | | | Presence or | | | |
| | Resin | aromatic | | | absence of use | | | |
| | Polyarylate | carboxylic | Silicone oil | | +: used | | Performance evaluation | |
| | Type | acid halide | Type | Proportion | −: unused | | Surface | Surface |
| | Number | ×10⁻⁸ mol/g | — | ppm | — | — | roughness | repulsion |
| Example A1 | PA1 | 5 | Dimethyl silicone oil KF96 | 100.0000 | + | + | C | C |
| Example A2 | PA1 | 5 | Silicone graft polymer KL700 | 100.0000 | + | + | S | S |
| Example A3 | PA1 | 10 | Silicone graft polymer KL700 | 100.0000 | + | + | S | S |
| Example A4 | PA1 | 12 | Silicone graft polymer KL700 | 100.0000 | + | + | A | A |
| Example A5 | PA1 | 15 | Silicone graft polymer KL700 | 100.0000 | + | + | B | A |
| Example A6 | PA1 | 5 | Silicone graft polymer KL700 | 10.0000 | + | + | A | A |
| Example A7 | PA1 | 5 | Silicone graft polymer KL700 | 500.0000 | + | + | A | A |
| Example A8 | PA1 | 5 | Silicone graft polymer KL700 | 1000.0000 | + | + | B | A |
| Example A9 | PA1 | 5 | Silicone graft polymer KL700 | 0.0100 | + | + | B | A |
| Example A10 | PA1 | 5 | Silicone graft polymer KL700 | 15000.0000 | + | + | C | C |
| Example A11 | PA1 | 5 | Silicone graft polymer KL700 | 0.0010 | + | + | C | C |
| Example A12 | PA1 | 5 | Ether-modified silicone oil KP340 | 60.0000 | + | − | S | S |
| Example A13 | PA1 | 10 | Ether-modified silicone oil KP340 | 100.0000 | + | − | S | S |
| Example A14 | PA1 | 12 | Ether-modified silicone oil KP340 | 100.0000 | + | − | A | A |
| Example A15 | PA1 | 15 | Ether-modified silicone oil KP340 | 100.0000 | + | − | B | A |
| Example A16 | PA1 | 5 | Ether-modified silicone oil KP340 | 10.0000 | + | − | A | A |
| Example A17 | PA1 | 5 | Ether-modified silicone oil KP340 | 500.0000 | + | − | A | A |
| Example A18 | PA1 | 5 | Ether-modified silicone oil KP340 | 1000.0000 | + | − | B | B |
| Example A19 | PA1 | 5 | Ether-modified silicone oil KP340 | 0.0100 | + | − | B | B |
| Example A20 | PA1 | 5 | Ether-modified silicone oil KP340 | 15000.0000 | + | − | C | C |
| Example A21 | PA1 | 5 | Ether-modified silicone oil KP340 | 0.0010 | + | − | C | C |
| Example A22 | PA1 | 5 | Ether-modified silicone oil KP340 | 100.0000 | + | − | C | C |
| Example A23 | PA1 | 5 | Ether-modified silicone oil KP340 | 100.0000 | + | − | B | B |
| Example A24 | PA1 | 5 | Ether-modified silicone oil KP340 | 100.0000 | + | − | B | B |
| Example A25 | PA1 | 5 | Ether-modified silicone oil KP340 | 100.0000 | + | − | C | C |
| Example A26 | PA1 | 5 | Cyclic siloxane compound 1 | 100.0000 | + | − | B | B |
| Example A27 | PA1 | 5 | Cyclic siloxane compound 8 | 100.0000 | + | − | B | B |
| Example A28 | PA1 | 5 | Cyclic siloxane compound 22 | 100.0000 | + | − | B | B |
| Example A29 | PA1 | 5 | Cyclic siloxane compound 29 | 100.0000 | + | − | B | B |
| Example A30 | PA2 | 5 | Silicone graft polymer KL700 | 100.0000 | + | + | B | B |
| Example A31 | PA3 | 5 | Silicone graft polymer KL700 | 100.0000 | + | + | B | B |
| Example A32 | PA4 | 5 | Silicone graft polymer KL700 | 100.0000 | + | + | B | B |
| Example A33 | PA5 | 5 | Silicone graft polymer KL700 | 100.0000 | + | + | B | B |
| Example A34 | PA6 | 5 | Silicone graft polymer KL700 | 100.0000 | + | + | B | B |
| Example A35 | PA7 | 5 | Silicone graft polymer KL700 | 100.0000 | + | + | B | B |
| Example A36 | PA1 | 5 | Silicone graft polymer KL700 | 100.0000 | + | + | B | B |
| Comparative | PA1 | 5 | None | 0.0000 | + | + | D | D |
| Example A1 | | | | | | | | |
| Comparative | PA1 | 15 | None | 0.0000 | + | + | D | D |
| Example A2 | | | | | | | | |
| Comparative | PA1 | 5 | Ether-modified silicone oil KP340 | 0.0001 | + | + | D | D |
| Example A3 | | | | | | | | |
| Comparative | PA1 | 5 | Ether-modified silicone oil KP340 | 20000.0000 | + | + | D | D |
| Example A4 | | | | | | | | |
| Comparative | PA1 | 20 | Ether-modified silicone oil KP340 | 0.0010 | + | + | D | D |
| Example A5 | | | | | | | | |

TABLE 4

| Outermost surface layer | | | |
|---|---|---|---|
| | | Residual | |
| | | amount of | |
| Resin | | aromatic | |
| Polyarylate | Polycarbonate | carboxylic | Silicone oil |

| | Type | Proportion | Type | Proportion | acid halide | | Proportion |
|---|---|---|---|---|---|---|---|
| | Number | Mass % | Number | Mass % | ×10⁻⁸ mol/g | Type | ppm |
| Example B1 | PA1 | 60 | PC1 | 40 | 5 | Dimethyl silicone oil KF96 | 100.0000 |
| Example B2 | PA1 | 60 | PC1 | 40 | 5 | Silicone graft polymer KL700 | 100.0000 |
| Example B3 | PA1 | 60 | PC1 | 40 | 10 | Silicone graft polymer KL700 | 100.0000 |
| Example B4 | PA1 | 60 | PC1 | 40 | 12 | Silicone graft polymer KL700 | 100.0000 |
| Example B5 | PA1 | 60 | PC1 | 40 | 15 | Silicone graft polymer KL700 | 100.0000 |
| Example B6 | PA1 | 60 | PC1 | 40 | 5 | Silicone graft polymer KL700 | 10.0000 |
| Example B7 | PA1 | 60 | PC1 | 40 | 5 | Silicone graft polymer KL700 | 500.0000 |
| Example B8 | PA1 | 60 | PC1 | 40 | 5 | Silicone graft polymer KL700 | 1000.0000 |
| Example B9 | PA1 | 60 | PC1 | 40 | 5 | Silicone graft polymer KL700 | 0.0100 |
| Example B10 | PA1 | 60 | PC1 | 40 | 5 | Silicone graft polymer KL700 | 15000.0000 |
| Example B11 | PA1 | 60 | PC1 | 40 | 5 | Silicone graft polymer KL700 | 0.0010 |
| Example B12 | PA1 | 30 | PC1 | 70 | 5 | Ether-modified silicone oil KP340 | 60.0000 |
| Example B13 | PA1 | 30 | PC1 | 70 | 10 | Ether-modified silicone oil KP340 | 100.0000 |
| Example B14 | PA1 | 30 | PC1 | 70 | 12 | Ether-modified silicone oil KP340 | 100.0000 |
| Example B15 | PA1 | 30 | PC1 | 70 | 15 | Ether-modified silicone oil KP340 | 100.0000 |
| Example B16 | PA1 | 30 | PC1 | 70 | 5 | Ether-modified silicone oil KP340 | 10.0000 |
| Example B17 | PA1 | 30 | PC1 | 70 | 5 | Ether-modified silicone oil KP340 | 500.0000 |
| Example B18 | PA1 | 30 | PC1 | 70 | 5 | Ether-modified silicone oil KP340 | 1000.0000 |
| Example B19 | PA1 | 30 | PC1 | 70 | 5 | Ether-modified silicone oil KP340 | 0.0100 |
| Example B20 | PA1 | 30 | PC1 | 70 | 5 | Ether-modified silicone oil KP340 | 15000.0000 |
| Example B21 | PA1 | 30 | PC1 | 70 | 5 | Ether-modified silicone oil KP340 | 0.0010 |
| Example B22 | PA1 | 80 | PC1 | 20 | 5 | Ether-modified silicone oil KP340 | 100.0000 |
| Example B23 | PA1 | 75 | PC1 | 25 | 5 | Ether-modified silicone oil KP340 | 100.0000 |
| Example B24 | PA1 | 25 | PC1 | 75 | 5 | Ether-modified silicone oil KP340 | 100.0000 |
| Example B25 | PA1 | 20 | PC1 | 80 | 5 | Ether-modified silicone oil KP340 | 100.0000 |
| Example B26 | PA1 | 30 | PC1 | 70 | 5 | Cyclic siloxane compound 1 | 100.0000 |
| Example B27 | PA1 | 30 | PC1 | 70 | 5 | Cyclic siloxane compound 8 | 100.0000 |
| Example B28 | PA1 | 30 | PC1 | 70 | 5 | Cyclic siloxane compound 22 | 100.0000 |
| Example B29 | PA1 | 30 | PC1 | 70 | 5 | Cyclic siloxane compound 29 | 100.0000 |
| Example B30 | PA2 | 60 | PC1 | 40 | 5 | Silicone graft polymer KL700 | 100.0000 |
| Example B31 | PA3 | 60 | PC1 | 40 | 5 | Silicone graft polymer KL700 | 100.0000 |
| Example B32 | PA4 | 60 | PC1 | 40 | 5 | Silicone graft polymer KL700 | 100.0000 |
| Example B33 | PA5 | 60 | PC1 | 40 | 5 | Silicone graft polymer KL700 | 100.0000 |
| Example B34 | PA6 | 60 | PC1 | 40 | 5 | Silicone graft polymer KL700 | 100.0000 |
| Example B35 | PA7 | 60 | PC1 | 40 | 5 | Silicone graft polymer KL700 | 100.0000 |
| Example B36 | PA1 | 60 | PC2 | 40 | 5 | Silicone graft polymer KL700 | 100.0000 |
| Example B37 | PA1 | 60 | PC3 | 40 | 5 | Silicone graft polymer KL700 | 100.0000 |
| Comparative | PA1 | 60 | PC1 | 40 | 5 | None | 0.0000 |
| Example B1 | | | | | | | |
| Comparative | PA1 | 60 | PC1 | 40 | 15 | None | 0.0000 |
| Example B2 | | | | | | | |
| Comparative | PA1 | 60 | PC1 | 40 | 5 | Ether-modified silicone oil KP340 | 0.0001 |
| Example B3 | | | | | | | |
| Comparative | PA1 | 60 | PC1 | 40 | 5 | Ether-modified silicone oil KP340 | 20000.0000 |
| Example B4 | | | | | | | |
| Comparative | PA1 | 60 | PC1 | 40 | 20 | Ether-modified silicone oil KP340 | 0.0010 |
| Example B5 | | | | | | | |

| | Outermost surface layer | | | |
|---|---|---|---|---|
| | Charge transport material | | | |
| | CTM-1 | CTM-2 | | |
| | Presence or absence of use | | | |
| | +: used | | Performance evaluation | |
| | −: unused | | Surface | Surface |
| | — | — | roughness | repulsion |
| Example B1 | + | + | C | C |
| Example B2 | + | + | S | S |
| Example B3 | + | + | S | S |
| Example B4 | + | + | A | A |
| Example B5 | + | + | B | A |
| Example B6 | + | + | A | A |
| Example B7 | + | + | A | A |
| Example B8 | + | + | B | A |
| Example B9 | + | + | B | A |
| Example B10 | + | + | C | C |
| Example B11 | + | + | C | C |
| Example B12 | + | − | S | S |
| Example B13 | + | − | S | S |
| Example B14 | + | − | A | A |
| Example B15 | + | − | A | A |
| Example B16 | + | − | A | A |
| Example B17 | + | − | A | A |
| Example B18 | + | − | B | B |
| Example B19 | + | − | B | B |
| Example B20 | + | − | C | C |
| Example B21 | + | − | C | C |
| Example B22 | + | − | C | C |
| Example B23 | + | − | B | B |
| Example B24 | + | − | B | B |
| Example B25 | + | − | C | C |
| Example B26 | + | − | B | B |
| Example B27 | + | − | B | B |
| Example B28 | + | − | B | B |
| Example B29 | + | − | B | B |
| Example B30 | + | + | B | B |
| Example B31 | + | + | B | B |
| Example B32 | + | + | B | B |
| Example B33 | + | + | B | B |
| Example B34 | + | + | B | B |
| Example B35 | + | + | B | B |
| Example B36 | + | + | B | B |
| Example B37 | + | + | C | C |
| Comparative | + | + | D | D |
| Example B1 | | | | |
| Comparative | + | + | D | D |
| Example B2 | | | | |
| Comparative | + | + | D | D |
| Example B3 | | | | |
| Comparative | + | + | D | D |
| Example B4 | | | | |
| Comparative | + | + | D | D |
| Example B5 | | | | |

The electrophotographic photoreceptor, the process cartridge, and the image forming apparatus according to the present disclosure include the following aspects. Each formula is the same as the formula having the same number described above.

### SUPPLEMENTARY NOTES

(((1))) An electrophotographic photoreceptor comprising:
a conductive substrate; and
a photosensitive layer disposed on the conductive substrate,
wherein an outermost surface layer contains a charge transport material, a polyarylate resin, and silicone oil, and
a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

(((2))) The electrophotographic photoreceptor according to (((1))),
wherein the content of the silicone oil in the outermost surface layer is 0.010 ppm or more and 10000.000 ppm or less.

(((3))) The electrophotographic photoreceptor according to (((2))),
wherein the content of the silicone oil in the outermost surface layer is 10.000 ppm or more and 500.000 ppm or less.

(((4))) The electrophotographic photoreceptor according to any one of (((1))) to (((3))),
wherein the outermost surface layer further contains a polycarbonate resin.

(((5))) The electrophotographic photoreceptor according to any one of (((1))) to (((4))),
wherein the polyarylate resin has a dicarboxylic acid unit represented by Formula (A) and a diol unit represented by Formula (B),

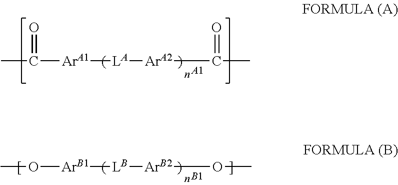

in Formula (A), Ar^{A1} and Ar^{A} are each independently an aromatic ring which may have a substituent, L^{A} is a single bond or a divalent linking group, and n^{A1} is 0, 1, or 2,
in Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

(((6))) The electrophotographic photoreceptor according to (((4))) or (((5))),
wherein the polyarylate resin and the polycarbonate resin each have a constitutional unit including biphenyl represented by Formula (BP),

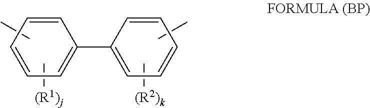

in Formula (BP), j is an integer of 0 or greater and 4 or less, j pieces of R¹'s are each independently a methyl group or an ethyl group, k is an integer of 0 or greater and 4 or less, and k pieces of R²'s are each independently a methyl group or an ethyl group.

(((7))) The electrophotographic photoreceptor according to any one of (((1))) to (((6))),
wherein the silicone oil includes at least one selected from the group consisting of ether-modified silicone oil, a silicone-grafted acrylic polymer, and a cyclic siloxane compound.

(((8))) A process cartridge comprising:
the electrophotographic photoreceptor according to any one of (((1))) to (((7))),
wherein the process cartridge is attachable to and detachable from an image forming apparatus.

(((9))) An image forming apparatus comprising:
the electrophotographic photoreceptor according to any one of (((1))) to (((7)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a photosensitive layer disposed on the conductive substrate,
wherein an outermost surface layer contains a charge transport material, a polyarylate resin, and silicone oil, and
a content of the silicone oil is 0.001 ppm or more and 15000.000 ppm or less with respect to the outermost surface layer, and a residual amount of an aromatic carboxylic acid halide per unit mass of the outermost surface layer is 15×10⁻⁸ mol/g or less.

2. The electrophotographic photoreceptor according to claim 1,
wherein the content of the silicone oil in the outermost surface layer is 0.010 ppm or more and 10000.000 ppm or less.

3. The electrophotographic photoreceptor according to claim 2,
wherein the content of the silicone oil in the outermost surface layer is 10.000 ppm or more and 500.000 ppm or less.

4. The electrophotographic photoreceptor according to claim 1,
wherein the outermost surface layer further contains a polycarbonate resin.

5. The electrophotographic photoreceptor according to claim 1,
wherein the polyarylate resin has a dicarboxylic acid unit represented by Formula (A) and a diol unit represented by Formula (B), 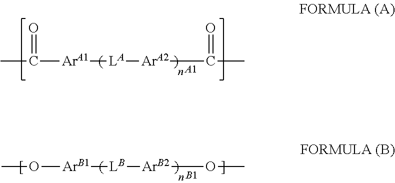
in Formula (A), Ar^{A1} and Ar^{A2} are each independently an aromatic ring which may have a substituent, L^{A} is a single bond or a divalent linking group, and n^{A1} is 0, 1, or 2,
in Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

6. The electrophotographic photoreceptor according to claim 4,
wherein the polyarylate resin and the polycarbonate resin each have a constitutional unit including biphenyl represented by Formula (BP), 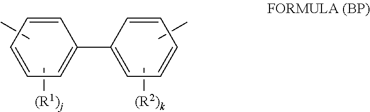
in Formula (BP), j is an integer of 0 or greater and 4 or less, j pieces of R's are each independently a methyl group or an ethyl group, k is an integer of 0 or greater and 4 or less, and k pieces of R²'s are each independently a methyl group or an ethyl group.

7. The electrophotographic photoreceptor according to claim 1,
wherein the silicone oil includes at least one selected from the group consisting of ether-modified silicone oil, a silicone-grafted acrylic polymer, and a cyclic siloxane compound.

8. A process cartridge comprising:
the electrophotographic photoreceptor according to claim 1,
wherein the process cartridge is attachable to and detachable from an image forming apparatus.

9. A process cartridge comprising:
the electrophotographic photoreceptor according to claim 2,
wherein the process cartridge is attachable to and detachable from an image forming apparatus.

10. A process cartridge comprising:
the electrophotographic photoreceptor according to claim 3,
wherein the process cartridge is attachable to and detachable from an image forming apparatus.

11. A process cartridge comprising:
the electrophotographic photoreceptor according to claim 4,
wherein the process cartridge is attachable to and detachable from an image forming apparatus.

12. A process cartridge comprising:
the electrophotographic photoreceptor according to claim 5,
wherein the process cartridge is attachable to and detachable from an image forming apparatus.

13. A process cartridge comprising:
the electrophotographic photoreceptor according to claim 6,
wherein the process cartridge is attachable to and detachable from an image forming apparatus.

14. A process cartridge comprising:
the electrophotographic photoreceptor according to claim 7,
wherein the process cartridge is attachable to and detachable from an image forming apparatus.

15. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

16. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

17. An image forming apparatus comprising:
the electrophotographic photoreceptor according to claim 3;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor according to claim 4;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. An image forming apparatus comprising:
the electrophotographic photoreceptor according to claim 5;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. An image forming apparatus comprising:
the electrophotographic photoreceptor according to claim 6;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
